(19) United States
(12) Patent Application Publication
(10) Pub. No.: US 2023/0334289 A1
(43) Pub. Date: Oct. 19, 2023

(54) DEEP NEURAL NETWORK ACCELERATOR WITH MEMORY HAVING TWO-LEVEL TOPOLOGY

(71) Applicant: Intel Corporation, Santa Clara, CA (US)

(72) Inventors: Robert Cezary Zaglewski, Folsom, CA (US); Deepak Abraham Mathaikutty, Chandler, AZ (US)

(73) Assignee: Intel Corporation, Santa Clara, CA (US)

(21) Appl. No.: 18/337,655

(22) Filed: Jun. 20, 2023

(51) Int. Cl. G06N 3/044

(52) U.S. Cl. CPC G06N 3/044

(57) ABSTRACT

A deep neural network (DNN) accelerator includes one or more compute blocks that perform deep learning operations in DNNs. A compute block includes a memory and one or more processing elements. The memory may include bank groups, each of which includes memory banks. The memory may also include a group selection module, buffers, interconnects, and bank selection modules. The group selection module may select a bank group for a data transfer request from a processing element and store the data transfer request in a buffer associated with the bank group. The memory address in the data transfer request may be transmitted from the buffer to a bank selection module associated with the bank group through an interconnect. The bank selection module may select a memory bank in the bank group based on the memory address. Data can be read from or written into the selected memory bank.

### TECHNICAL FIELD

This disclosure relates generally to deep neural networks (DNN), and more specifically, DNN accelerators with memories having two-level topologies.

### BACKGROUND

DNNs are used extensively for a variety of artificial intelligence applications ranging from computer vision to speech recognition and natural language processing due to their ability to achieve high accuracy. However, the high accuracy comes at the expense of significant computation cost. DNNs have extremely high computing demands as each inference can require hundreds of millions of MAC (multiply-accumulate) operations as well as a large amount of data to read and write. Therefore, techniques to improve efficiency of DNNs are needed.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 illustrates an example DNN, in accordance with various embodiments.

FIG. 2 illustrates an example convolution, in accordance with various embodiments.

FIG. 3 is a block diagram of a DNN accelerator, in accordance with various embodiments.

FIG. 4 illustrates an example request path in a local memory, in accordance with various embodiments.

FIG. 5 illustrates an example response path in a local memory, in accordance with various embodiments.

FIG. 6 illustrates clock cycles for a request path response path in a local memory, in accordance with various embodiments.

FIG. 7 illustrates clock cycles for a response path in a local memory, in accordance with various embodiments.

FIGS. 8A and 8B illustrate a process of assigning banks 860A-860P to bank groups 840A-840D, in accordance with various embodiments.

FIG. 9 illustrates an example local memory with one-level topology, in accordance with various embodiments.

FIG. 10 illustrates clock cycles for a request path in the local memory of FIG. 9, in accordance with various embodiments.

FIG. 11 illustrates clock cycles for a response path in the local memory of FIG. 9, in accordance with various embodiments.

FIG. 12 is a block diagram of a processing element (PE), in accordance with various embodiments.

FIG. 13 illustrates a PE array, in accordance with various embodiments.

FIG. 14 is a flowchart showing a method of data transfer for deep learning, in accordance with various embodiments.

FIG. 15 is a block diagram of an example computing device, in accordance with various embodiments.

### DETAILED DESCRIPTION

### Overview

The last decade has witnessed a rapid rise in AI (artificial intelligence) based data processing, particularly based on DNNs. DNNs are widely used in the domains of computer vision, speech recognition, image, and video processing mainly due to their ability to achieve beyond human-level accuracy. The significant improvements in DNN model size and accuracy coupled with the rapid increase in computing power of execution platforms have led to the adoption of DNN applications even within resource constrained mobile and edge devices that have limited energy availability.

A DNN layer may include one or more deep learning operations, such as convolution, pooling, elementwise operation, linear operation, nonlinear operation, and so on. A deep learning operation in a DNN may be performed on one or more internal parameters of the DNNs (e.g., weights), which are determined during the training phase, and one or more activations. An activation may be a data point (also referred to as “data elements” or “elements”). Activations or weights of a DNN layer may be elements of a tensor of the DNN layer. A tensor is a data structure having multiple elements across one or more dimensions. Example tensors include a vector, which is a one-dimensional tensor, and a matrix, which is a two-dimensional tensor. There can also be three-dimensional tensors and even higher dimensional tensors. A DNN layer may have an input tensor (also referred to as “input feature map (IFM)”) including one or more input activations (also referred to as “input elements”) and a weight tensor including one or more weights. A weight is an element in the weight tensor. A weight tensor of a convolution may be a kernel, a filter, or a group of filters. The output data of the DNN layer may be an output tensor (also referred to as “output feature map (OFM)”) that includes one or more output activations (also referred to as “output elements”).

Some DNNs, such as convolutional neural networks (CNNs), have become highly influential in the field of computer vision and image processing. However, the complex nature of the CNN architectures (e.g., billions of parameters) makes it difficult to deploy them in real time. CNN models require significantly large investment in compute resources and incur significant energy costs. Furthermore, the bandwidth required to load data into the DNN accelerator is a limiting factor when moving weights and activations between the on-chip memory and the PE array. The significant computational complexity comes from the over parameterization of the DNN model, which builds in redundancy and provides an opportunity for optimization. These redundancies can be removed through various hardware and software techniques with little or no loss of accuracy and a significant reduction in the amount of computation that needs to be performed.

Compute capacity of DNN accelerators has been growing due to technology process improvement as well as architectural innovations. With the increase in computation power (e.g., scaling of the numbers of PE and MAC units), memory bandwidth becomes greater the bottleneck as more DNN layers may not be able to reach the DNN accelerator’s peak performance. Another factor pushing DNNs into being memory bandwidth limited is fact that DNN inference accelerator’s on-chip memory is a significant portion of the total power due to the size and number of accesses performed by PEs to load/store parameters. For this reason, it is advantageous to select the DNN accelerator’s on-chip memory from low-power component libraries available for a specific technology node and to clock it using lower operating frequency comparing to PEs. Many DNN accelerators use a clock ratio of 1:2 or 4:7 between the PEs and the on-chip memory. Bandwidth utilization of the memory bandwidth efficiently becomes a crucial problem to solve to address the performance bottleneck due to memory bound DNN-based applications.

On-chip memory is usually built out of multiple static random-access memories (SRAM) banks which are connected to the access ports of PEs using an interconnect fabric made of multiple links with assigned bandwidth that the PEs can utilize to load/store model parameters and inference results. Memory banks can be organized in series without any additional grouping or hierarchy that is aware of the inherent nature of the access pattern. The interconnect is usually responsible for managing the flow of data using address mapping to ensure data is stored in correct memory banks. It is usually also responsible for managing the clock crossing and moving data back and forth between the faster compute domain and the slower memory domain. Many DNN accelerators use an address interleaving technique to optimize transfer rate between PEs and memory banks.

In a typical address interleaving scheme, linearly increasing memory address is sweeping first through memory banks and in second order through words within banks. Interleaving can enable efficient use of memory by allowing multiple PEs ports target contiguous memory location simultaneously as those are directed to different memory banks. For example, if PE port #0 accesses on-chip memory location #0 while PE port #1 accesses on-chip memory location #1, both these requests can proceed in parallel as interconnect directs them respectively to Bank #0/Word #0 and Bank #1/Word #0. However, the port bandwidth of the PE can be limited by the rate at which the requests are pulled out of the clock domain crossing components using the slow clock of the interconnect fabric. This design constraint can result in low bandwidth utilization. For instance, it can be about 50% of the PE port utilization with 2:1 clock ratio between the PE clock and interconnect clock.

Embodiments of the present disclosure provide DNN accelerators with memories that can boost bandwidth utilization. An example DNN accelerator in the present disclosure includes one or more compute blocks. A compute block may also be referred to as a compute tile. Each compute block may be a processing unit. A compute block includes a memory and one or more PEs. The memory can store data used or generated by the PEs. The memory is local to the compute block and can be arranged on the same chip as the PEs. The memory includes a plurality of memory banks, which can be grouped in accordance with DNN-centric traffic patterns on the ports of the PEs to increase the memory bandwidth utilization and minimize memory access contention.

In various embodiments of the present disclosure, a local memory of a compute block in a DNN accelerator may have a two-level topology: the first level includes bank groups, and the second level includes memory banks (also referred to as “banks”). Each bank group includes a different subset of the memory banks in the local memory. The memory may also include a group selection module (e.g., a demultiplexer), buffers, and interconnects. Each buffer may be specific to a particular bank group. A buffer (e.g., a clock domain crossing (CDC) first in first out (FIFO)) may be communicatively coupled to the corresponding bank group through a particular interconnect. A bank group may also include a bank selection module (e.g., a demultiplexer). The group selection module may receive data transfer requests (also referred to as “requests”) from one or more host ports of the PEs. The data transferred requests may be generated by the PEs or a control module in the compute block. A data transfer request may be a request to read data (e.g., data to be used by the PEs for performing a deep learning operating in a DNN) from the memory or write data (e.g., data computed by the PEs by performing a deep learning operating in a DNN) into the memory. A data transfer request may include the data to be read or written, one or more memory addresses where the data is to be read or written, or other information.

The group selection module may select a bank group for a data transfer request and store the data transfer request (or part of the data transfer request) in the buffer coupled to the bank group. In some embodiments, the group selection module may not select the same bank group for two consecutive requests (i.e., two requests that are received by the group selection module consecutively without a third request in between). The data transfer request may be transmitted from the buffer to the bank selection module in the bank group through the interconnect between the buffer and the bank group. The bank selection module may select a memory bank for the data transfer request, e.g., based on the memory address. Data can be read from or written into the selected memory bank. The memory bank can also provide a response to the data transfer request, which can be sent to an arbiter in the bank group, further to the buffer coupled to the bank group. The response can then be read from the buffer by a group arbiter of the memory that is coupled to the host post. The PE can receive the response through the host post.

The two-level topology of the local memory can increase bandwidth utilization of the local memory. The group selection module may be in the same clock domain as the host port, which is faster than the clock domain including the interconnects and the banks. In many currently available DNN accelerators, backpressure can be present and stall PEs from sending more data transfer requests after a certain number of requests are sent, as reading requests from the CDC FIFO is on a slower clock than writing request into the CDC FIFO and is not able to keep up with fast running PE ports. This backpressure can force the PEs to slow down to the rate at which the requests are being pulled out by the interconnect. The backpressure can therefore cause undesirable bandwidth utilization.

However, with the two-level topology of the local memory in the present disclosure, the group selection module can send consecutive requests to different groups, which can boost the bandwidth utilization. The memory bandwidth improvement can enable higher computation efficiency by better PE utilization and less starvation. Despite these advantages, the two-level memory topology in the present disclosure does not require significantly more power or area. Rather, it can lead to less wasted compute cycles and energy savings given the improved bandwidth utilization.

For purposes of explanation, specific numbers, materials and configurations are set forth in order to provide a thorough understanding of the illustrative implementations. However, it will be apparent to one skilled in the art that the present disclosure may be practiced without the specific details or/and that the present disclosure may be practiced with only some of the described aspects. In other instances, well known features are omitted or simplified in order not to obscure the illustrative implementations.

Further, references are made to the accompanying drawings that form a part hereof, and in which is shown, by way of illustration, embodiments that may be practiced. It is to be understood that other embodiments may be utilized, and structural or logical changes may be made without departing from the scope of the present disclosure. Therefore, the following detailed description is not to be taken in a limiting sense.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order from the described embodiment. Various additional operations may be performed or described operations may be omitted in additional embodiments.

For the purposes of the present disclosure, the phrase “A or B” or the phrase “A and/or B” means (A), (B), or (A and B). For the purposes of the present disclosure, the phrase “A, B, or C” or the phrase “A, B, and/or C” means (A), (B), (C), (A and B), (A and C), (B and C), or (A, B, and C). The term “between,” when used with reference to measurement ranges, is inclusive of the ends of the measurement ranges.

The description uses the phrases “in an embodiment” or “in embodiments,” which may each refer to one or more of the same or different embodiments. The terms “comprising,” “including,” “having,” and the like, as used with respect to embodiments of the present disclosure, are synonymous. The disclosure may use perspective-based descriptions such as “above,” “below,” “top,” “bottom,” and “side” to explain various features of the drawings, but these terms are simply for ease of discussion, and do not imply a desired or required orientation. The accompanying drawings are not necessarily drawn to scale. Unless otherwise specified, the use of the ordinal adjectives “first,” “second,” and “third,” etc., to describe a common object, merely indicates that different instances of like objects are being referred to and are not intended to imply that the objects so described must be in a given sequence, either temporally, spatially, in ranking or in any other manner.

In the following detailed description, various aspects of the illustrative implementations will be described using terms commonly employed by those skilled in the art to convey the substance of their work to others skilled in the art.

The terms “substantially,” “close,” “approximately,” “near,” and “about,” generally refer to being within +/- 20% of a target value as described herein or as known in the art. Similarly, terms indicating orientation of various elements, e.g., “coplanar,” “perpendicular,” “orthogonal,” “parallel,” or any other angle between the elements, generally refer to being within +/- 5-20% of a target value as described herein or as known in the art.

In addition, the terms “comprise,” “comprising,” “include,” “including,” “have,” “having” or any other variation thereof, are intended to cover a non-exclusive inclusion. For example, a method, process, device, or DNN accelerator that comprises a list of elements is not necessarily limited to only those elements but may include other elements not expressly listed or inherent to such method, process, device, or DNN accelerators. Also, the term “or” refers to an inclusive “or” and not to an exclusive “or.”

The systems, methods and devices of this disclosure each have several innovative aspects, no single one of which is solely responsible for all desirable attributes disclosed herein. Details of one or more implementations of the subject matter described in this specification are set forth in the description below and the accompanying drawings.

### Example DNN

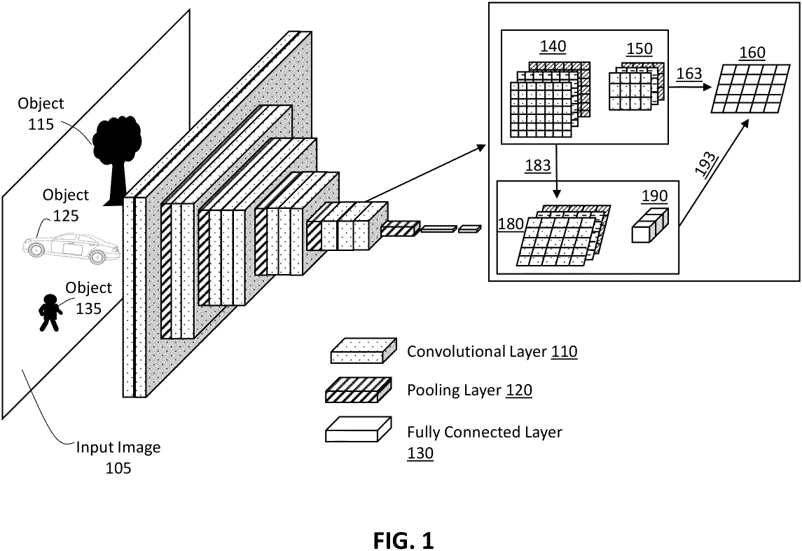

FIG. 1 illustrates an example DNN 100, in accordance with various embodiments. For purpose of illustration, the DNN 100 in FIG. 1 is a CNN. In other embodiments, the DNN 100 may be other types of DNNs. The DNN 100 is trained to receive images and output classifications of objects in the images. In the embodiments of FIG. 1, the DNN 100 receives an input image 105 that includes objects 115, 125, and 135. The DNN 100 includes a sequence of layers comprising a plurality of convolutional layers 110 (individually referred to as “convolutional layer 110”), a plurality of pooling layers 120 (individually referred to as “pooling layer 120”), and a plurality of fully connected layers 130 (individually referred to as “fully connected layer 130”). In other embodiments, the DNN 100 may include fewer, more, or different layers. In an inference of the DNN 100, the layers of the DNN 100 execute tensor computation that includes many tensor operations, such as convolution (e.g., multiply-accumulate (MAC) operations, etc.), pooling operations, elementwise operations (e.g., elementwise addition, elementwise multiplication, etc.), other types of tensor operations, or some combination thereof.

The convolutional layers 110 summarize the presence of features in the input image 105. The convolutional layers 110 function as feature extractors. The first layer of the DNN 100 is a convolutional layer 110. In an example, a convolutional layer 110 performs a convolution on an input tensor 140 (also referred to as IFM 140) and a filter 150. As shown in FIG. 1, the IFM 140 is represented by a 7×7×3 three-dimensional (3D) matrix. The IFM 140 includes 3 input channels, each of which is represented by a 7×7 two-dimensional (2D) matrix. The 7×7 2D matrix includes 7 input elements (also referred to as input points) in each row and 7 input elements in each column. The filter 150 is represented by a 3×3×3 3D matrix. The filter 150 includes 3 kernels, each of which may correspond to a different input channel of the IFM 140. A kernel is a 2D matrix of weights, where the weights are arranged in columns and rows. A kernel can be smaller than the IFM. In the embodiments of FIG. 1, each kernel is represented by a 3×3 2D matrix. The 3×3 kernel includes 3 weights in each row and 3 weights in each column. Weights can be initialized and updated by backpropagation using gradient descent. The magnitudes of the weights can indicate importance of the filter 150 in extracting features from the IFM 140.

The convolution includes MAC operations with the input elements in the IFM 140 and the weights in the filter 150. The convolution may be a standard convolution 163 or a depthwise convolution 183. In the standard convolution 163, the whole filter 150 slides across the IFM 140. All the input channels are combined to produce an output tensor 160 (also referred to as output feature map (OFM) 160). The OFM 160 is represented by a 5×5 2D matrix. The 5×5 2D matrix includes 5 output elements (also referred to as output points) in each row and 5 output elements in each column. For purpose of illustration, the standard convolution includes one filter in the embodiments of FIG. 1. In embodiments where there are multiple filters, the standard convolution may produce multiple output channels in the OFM 160.

The multiplication applied between a kernel-sized patch of the IFM 140 and a kernel may be a dot product. A dot product is the elementwise multiplication between the kernel-sized patch of the IFM 140 and the corresponding kernel, which is then summed, always resulting in a single value. Because it results in a single value, the operation is often referred to as the “scalar product.” Using a kernel smaller than the IFM 140 is intentional as it allows the same kernel (set of weights) to be multiplied by the IFM 140 multiple times at different points on the IFM 140. Specifically, the kernel is applied systematically to each overlapping part or kernel-sized patch of the IFM 140, left to right, top to bottom. The result from multiplying the kernel with the IFM 140 one time is a single value. As the kernel is applied multiple times to the IFM 140, the multiplication result is a 2D matrix of output elements. As such, the 2D output matrix (i.e., the OFM 160) from the standard convolution 163 is referred to as an OFM.

In the depthwise convolution 183, the input channels are not combined. Rather, MAC operations are performed on an individual input channel and an individual kernel and produce an output channel. As shown in FIG. 1, the depthwise convolution 183 produces a depthwise output tensor 180. The depthwise output tensor 180 is represented by a 5×5×3 3D matrix. The depthwise output tensor 180 includes 3 output channels, each of which is represented by a 5×5 2D matrix. The 5×5 2D matrix includes 5 output elements in each row and 5 output elements in each column. Each output channel is a result of MAC operations of an input channel of the IFM 140 and a kernel of the filter 150. For instance, the first output channel (patterned with dots) is a result of MAC operations of the first input channel (patterned with dots) and the first kernel (patterned with dots), the second output channel (patterned with horizontal strips) is a result of MAC operations of the second input channel (patterned with horizontal strips) and the second kernel (patterned with horizontal strips), and the third output channel (patterned with diagonal stripes) is a result of MAC operations of the third input channel (patterned with diagonal stripes) and the third kernel (patterned with diagonal stripes). In such a depthwise convolution, the number of input channels equals the number of output channels, and each output channel corresponds to a different input channel. The input channels and output channels are referred to collectively as depthwise channels. After the depthwise convolution, a pointwise convolution 193 is then performed on the depthwise output tensor 180 and a 1×1×3 tensor 190 to produce the OFM 160.

The OFM 160 is then passed to the next layer in the sequence. In some embodiments, the OFM 160 is passed through an activation function. An example activation function is the rectified linear activation function (ReLU). ReLU is a calculation that returns the value provided as input directly, or the value zero if the input is zero or less. The convolutional layer 110 may receive several images as input and calculate the convolution of each of them with each of the kernels. This process can be repeated several times. For instance, the OFM 160 is passed to the subsequent convolutional layer 110 (i.e., the convolutional layer 110 following the convolutional layer 110 generating the OFM 160 in the sequence). The subsequent convolutional layers 110 performs a convolution on the OFM 160 with new kernels and generates a new feature map. The new feature map may also be normalized and resized. The new feature map can be kernelled again by a further subsequent convolutional layer 110, and so on.

In some embodiments, a convolutional layer 110 has 4 hyperparameters: the number of kernels, the size F kernels (e.g., a kernel is of dimensions F×F×D pixels), the S step with which the window corresponding to the kernel is dragged on the image (e.g., a step of one means moving the window one pixel at a time), and the zero-padding P (e.g., adding a black contour of P pixels thickness to the input image of the convolutional layer 110). The convolutional layers 110 may perform various types of convolutions, such as 2-dimensional convolution, dilated or atrous convolution, spatial separable convolution, depthwise separable convolution, transposed convolution, and so on. The DNN 100 includes 16 convolutional layers 110. In other embodiments, the DNN 100 may include a different number of convolutional layers.

The pooling layers 120 down-sample feature maps generated by the convolutional layers, e.g., by summarizing the presence of features in the patches of the feature maps. A pooling layer 120 is placed between 2 convolution layers 110: a preceding convolutional layer 110 (the convolution layer 110 preceding the pooling layer 120 in the sequence of layers) and a subsequent convolutional layer 110 (the convolution layer 110 subsequent to the pooling layer 120 in the sequence of layers). In some embodiments, a pooling layer 120 is added after a convolutional layer 110, e.g., after an activation function (e.g., ReLU) has been applied to the OFM 160.

A pooling layer 120 receives feature maps generated by the preceding convolution layer 110 and applies a pooling operation to the feature maps. The pooling operation reduces the size of the feature maps while preserving their important characteristics. Accordingly, the pooling operation improves the efficiency of the DNN and avoids over-learning. The pooling layers 120 may perform the pooling operation through average pooling (calculating the average value for each patch on the feature map), max pooling (calculating the maximum value for each patch of the feature map), or a combination of both. The size of the pooling operation is smaller than the size of the feature maps. In various embodiments, the pooling operation is 2×2 pixels applied with a stride of 2 pixels, so that the pooling operation reduces the size of a feature map by a factor of 2, e.g., the number of pixels or values in the feature map is reduced to one quarter the size. In an example, a pooling layer 120 applied to a feature map of 6×6 results in an output pooled feature map of 3×3. The output of the pooling layer 120 is inputted into the subsequent convolution layer 110 for further feature extraction. In some embodiments, the pooling layer 120 operates upon each feature map separately to create a new set of the same number of pooled feature maps.

The fully connected layers 130 are the last layers of the DNN. The fully connected layers 130 may be convolutional or not. The fully connected layers 130 receive an input operand. The input operand defines the output of the convolutional layers 110 and pooling layers 120 and includes the values of the last feature map generated by the last pooling layer 120 in the sequence. The fully connected layers 130 apply a linear combination and an activation function to the input operand and generate a vector. The vector may contain as many elements as there are classes: element i represents the probability that the image belongs to class i. Each element is therefore between 0 and 1, and the sum of all is worth one. These probabilities are calculated by the last fully connected layer 130 by using a logistic function (binary classification) or a softmax function (multi-class classification) as an activation function.

In some embodiments, the fully connected layers 130 classify the input image 105 and return an operand of size N, where N is the number of classes in the image classification problem. In the embodiments of FIG. 1, N equals 3, as there are 3 objects 115, 125, and 135 in the input image. Each element of the operand indicates the probability for the input image 105 to belong to a class. To calculate the probabilities, the fully connected layers 130 multiply each input element by weight, make the sum, and then apply an activation function (e.g., logistic if N=2, softmax if N>2). This is equivalent to multiplying the input operand by the matrix containing the weights. In an example, the vector includes 3 probabilities: a first probability indicating the object 115 being a tree, a second probability indicating the object 125 being a car, and a third probability indicating the object 135 being a person. In other embodiments where the input image 105 includes different objects or a different number of objects, the individual values can be different.

### Example Convolution

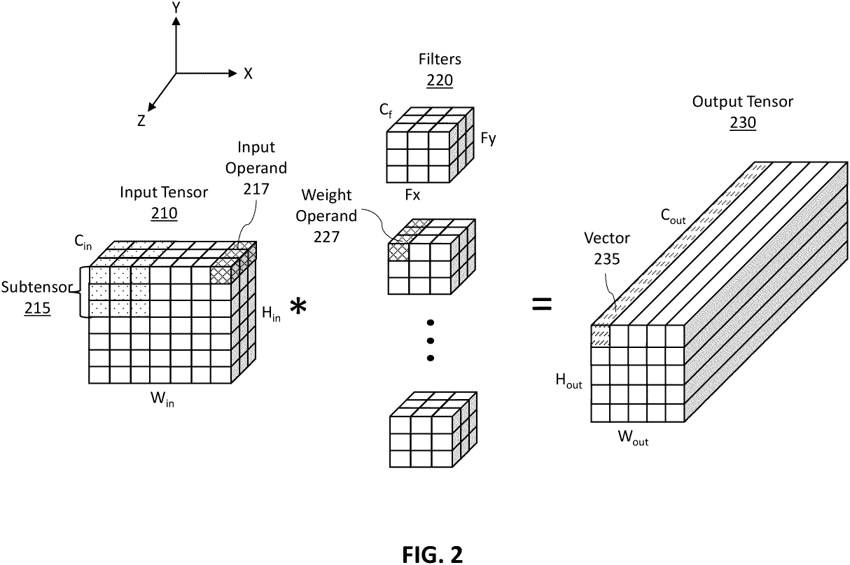

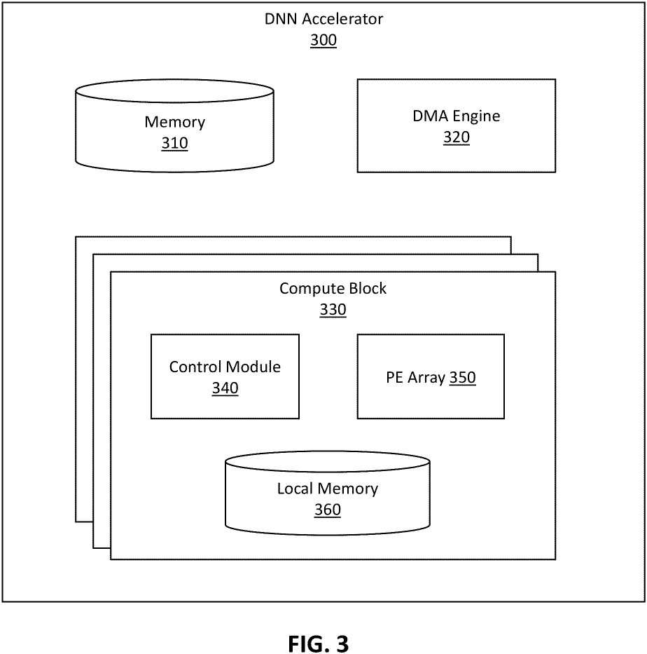

FIG. 2 illustrates an example convolution, in accordance with various embodiments. The convolution may be a convolution in a convolutional layer of a DNN, e.g., a convolutional layer 110 in FIG. 1. The convolution can be executed on an input tensor 210 and filters 220 (individually referred to as “filter 220”). A result of the convolution is an output tensor 230. In some embodiments, the convolution is performed by a DNN accelerator including one or more compute tiles. An example of the DNN accelerator may be the DNN accelerator 300 in FIG. 3. A compute tile may be a compute block, such as the compute block 330 in FIG. 3.

In the embodiments of FIG. 2, the input tensor 210 includes activations (also referred to as “input activations,” “elements,” or “input elements”) arranged in a 3D matrix. An input element is a data point in the input tensor 210. The input tensor 210 has a spatial size Hᵢₙ × Wᵢₙ × Cᵢₙ, where Hᵢₙ is the height of the 3D matrix (i.e., the length along the Y axis, which indicates the number of activations in a column in the 2D matrix of each input channel), Wᵢₙ is the width of the 3D matrix (i.e., the length along the X axis, which indicates the number of activations in a row in the 2D matrix of each input channel), and Cᵢₙ is the depth of the 3D matrix (i.e., the length along the Z axis, which indicates the number of input channels). For purpose of simplicity and illustration, the input tensor 210 has a spatial size of 7×7×3, i.e., the input tensor 210 includes three input channels and each input channel has a 7×7 2D matrix. Each input element in the input tensor 210 may be represented by a (X, Y, Z) coordinate. In other embodiments, the height, width, or depth of the input tensor 210 may be different.

Each filter 220 includes weights arranged in a 3D matrix. The values of the weights may be determined through training the DNN. A filter 220 has a spatial size H_{f} × W_{f} × C_{f}, where H_{f} is the height of the filter (i.e., the length along the Y axis, which indicates the number of weights in a column in each kernel), W_{f} is the width of the filter (i.e., the length along the X axis, which indicates the number of weights in a row in each kernel), and C_{f} is the depth of the filter (i.e., the length along the Z axis, which indicates the number of channels). In some embodiments, C_{f} equals Cᵢₙ. For purpose of simplicity and illustration, each filter 220 in FIG. 2 has a spatial size of 3×3×3, i.e., the filter 220 includes 3 convolutional kernels with a spatial size of 3×3. In other embodiments, the height, width, or depth of the filter 220 may be different. The spatial size of the convolutional kernels is smaller than the spatial size of the 2D matrix of each input channel in the input tensor 210.

An activation or weight may take one or more bytes in a memory. The number of bytes for an activation or weight may depend on the data format. For example, when the activation or weight has a INT8 format, the activation takes one byte. When the activation or weight has a FP16 format, the activation or weight takes two bytes. Other data formats may be used for activations or weights.

In the convolution, each filter 220 slides across the input tensor 210 and generates a 2D matrix for an output channel in the output tensor 230. In the embodiments of FIG. 2, the 2D matrix has a spatial size of 5×5. The output tensor 230 includes activations (also referred to as “output activations,” “elements,” or “output element”) arranged in a 3D matrix. An output activation is a data point in the output tensor 230. The output tensor 230 has a spatial size Hₒᵤₜ × Wₒᵤₜ × Cₒᵤₜ, where Hₒᵤₜ is the height of the 3D matrix (i.e., the length along the Y axis, which indicates the number of output activations in a column in the 2D matrix of each output channel), Wₒᵤₜ is the width of the 3D matrix (i.e., the length along the X axis, which indicates the number of output activations in a row in the 2D matrix of each output channel), and Cₒᵤₜ is the depth of the 3D matrix (i.e., the length along the Z axis, which indicates the number of output channels). Cₒᵤₜ may equal the number of filters 220 in the convolution. Hₒᵤₜ and Wₒᵤₜ may depend on the heights and weights of the input tensor 210 and each filter 220.

As a part of the convolution, MAC operations can be performed on a 3×3×3 subtensor 215 (which is highlighted with a dotted pattern in FIG. 2) in the input tensor 210 and each filter 220. The result of the MAC operations on the subtensor 215 and one filter 220 is an output activation. In some embodiments (e.g., embodiments where the convolution is an integral convolution), an output activation may include 8 bits, e.g., one byte. In other embodiments (e.g., embodiments where the convolution is a floating-point convolution), an output activation may include more than one byte. For instance, an output element may include two bytes.

After the MAC operations on the subtensor 215 and all the filters 220 are finished, a vector 235 is produced. The vector 235 is highlighted with slashes in FIG. 2. The vector 235 includes a sequence of output activations, which are arranged along the Z axis. The output activations in the vector 235 have the same (x, y) coordinate, but the output activations correspond to different output channels and have different Z coordinates. The dimension of the vector 235 along the Z axis may equal the total number of output channels in the output tensor 230. After the vector 235 is produced, further MAC operations are performed to produce additional vectors till the output tensor 230 is produced.

In some embodiments, the MAC operations on a 3×3×3 subtensor (e.g., the subtensor 215) and a filter 220 may be performed by a plurality of PEs. One or more PEs may receive an input operand (e.g., an input operand 217 shown in FIG. 2) and a weight operand (e.g., the weight operand 227 shown in FIG. 2). The input operand 217 includes a sequence of activations having the same (x, y) coordinate but different z coordinates. The input operand 217 includes an activation from each of the input channels in the input tensor 210. The weight operand 227 includes a sequence of weights having the same (x, y) coordinate but different z coordinates. The weight operand 227 includes a weight from each of the channels in the filter 220. Activations in the input operand 217 and weights in the weight operand 227 may be sequentially fed into a PE. The PE may receive a pair of an activation and a weight at a time and multiple the activation and the weight. The position of the activation in the input operand 217 may match the position of the weight in the weight operand 227. The activation and weight may correspond to the same channel.

Activations or weights may be floating-point numbers. Floating-point numbers may have various data formats, such as FP32, FP16, BF16, and so on. A floating-point number may be a positive or negative number with a decimal point. A floating-point number may be represented by a sequence of bits that includes one or more bits representing the sign of the floating-point number (e.g., positive or negative), bits representing an exponent of the floating-point number, and bits representing a mantissa of the floating-point number. The mantissa is the part of a floating-point number that represents the significant digits of that number. The mantissa is multiplied by the base raised to the exponent to give the actual value of the floating-point number.

### Example DNN Accelerator

FIG. 3 is a block diagram of an example DNN accelerator 300, in accordance with various embodiments. The DNN accelerator 300 can execute quantized deep learning operations in DNNs, e.g., the DNN 100 in FIG. 1. As shown in FIG. 3, the DNN accelerator 300 includes a memory 310, a DMA (direct memory access) engine 320, and compute blocks 330 (individually referred to as “compute block 330”). In other embodiments, alternative configurations, different or additional components may be included in the DNN accelerator 300. For example, the DNN accelerator 300 may include more than one memory 310 or DMA engine 320. As another example, the DNN accelerator 300 may include a single compute block 330. Further, functionality attributed to a component of the DNN accelerator 300 may be accomplished by a different component included in the DNN accelerator 300 or by a different system. A component of the DNN accelerator 300 may be implemented in hardware, software, firmware, or some combination thereof.

The memory 310 stores data associated with deep learning operations (including quantized deep learning operations) performed by the DNN accelerator. For instance, the memory 310 may store data generated and used by the compute blocks 330 for performing deep learning operations. Example deep learning operations include convolutions (also referred to as “convolutional operations”), pooling operations, elementwise operations, other types of deep learning operations, or some combination thereof.

In an example, the memory 310 may store input activations, weights, and output activations of a convolution in a convolutional layer of a DNN, e.g., the convolutional layer 130. The input activations and weights may be transmitted from the memory to 310 a local memory of a compute block 330 through the DMA engine 320. The output activations may be transmitted from a local memory of a compute block 330 to the memory 310 through the DMA engine 320. In some embodiments, the memory 310 may store the quantized values of the input activations, weights, and output activations, in lieu of their real values. The memory 310 may also store quantization parameters for transforming the real values to the quantized values, or vice versa. The memory 310 may be a main memory of the DNN accelerator 300. In some embodiments, the memory 310 includes one or more DRAMs (dynamic random-access memory).

The DMA engine 320 facilitates data transfer between the memory 310 and local memories of the compute blocks 330. For example, the DMA engine 320 can read data from the memory 310 and write data into a local memory of a compute block 330. As another example, the DMA engine 320 can read data from a local memory of a compute block 330and write data into the memory 310. The DMA engine 320 provides a DMA feature that allows the compute block 330 to initiate data transfer between the memory 310 and the local memories of the compute blocks 330 and to perform other operations while the data transfer is in being conducted. In some embodiments, the DMA engine 320 may read tensors from the memory 310, modify the tensors in a way that is optimized for the compute block 330 before it writes the tensors into the local memories of the compute blocks 330.

The compute blocks 330 can perform deep learning operations in DNNs. For instance, a compute block 330 may run a deep learning operation in a DNN layer, or a portion of the deep learning operation, at a time. The compute blocks 330 may be capable of running various types of deep learning operations, such as convolution, pooling, elementwise operation, linear operation, nonlinear operation, and so on. In an example, a compute block 330 may perform convolutions, e.g., standard convolution or depthwise convolution. In some embodiments, the compute block 330 receives an input tensor and one or more convolutional kernels and performs a convolution with the input tensor and convolutional kernels. The result of the convolution may be an output tensor, which can be further computed, e.g., by the compute block 330 or another compute block 330. In some embodiments, the operations of the DNN layers may be run by multiple compute blocks 330 in parallel. For instance, multiple compute blocks 330 may each perform a portion of a workload for a convolution. Data may be shared between the compute blocks 330.

In the embodiments of FIG. 3, each compute block 330 includes a control module 340, a PE array 350, and a local memory 360. In other embodiments, alternative configurations, different or additional components may be included in the compute block 330. Further, functionality attributed to a component of the compute block 330 may be accomplished by a different component included in the compute block 330 or the DNN accelerator 300 or by a different system. A component of the compute block 330 may be implemented in hardware, software, firmware, or some combination thereof.

The control module 340 controls one or more other components of the compute block 330. For instance, the control module 340 may control data transfer between the PE array 350 and the local memory 360. The control module 340 may read data (e.g., input activations, weights, etc.) from the local memory 360 into the PE array 350. The control module 340 may also data (e.g., output activations, etc.) from the PE array 350 into the local memory 360. In some embodiments, the control module 340 may transfer input activations into an input storage unit in the PE array 350. The input storage unit may include one or more register files for storing input activations to be used for MAC operations. The control module 340 may also transfer weights into a weight storage unit in the PE array 350. The weight storage unit may include one or more register files for storing weights to be used for MAC operations. The control module 340 can transfer data generated by the PE array 350 into the local memory 360. The data may be results of MAC operations performed by the PE array 350, such as output activations.

In some embodiments, the control module 340 may generate data transfer requests or manage the generation of data transfer requests by the PE array 350. A data transfer request may be a request to transfer data between the PE array 350 and the local memory 360. A data transfer request may be a read request to read data from the local memory 360, such as activations or weights that the PE array 350 can use to perform a deep learning operation. Additionally or alternatively, a data transfer request may be a write request to write data computed by the PE array 350 into the local memory 360. The control module 340 may also facilitate transmission of response to data transfer requests from the local memory 360 to the PE array 350.

In some embodiments, the control module 340 may manage clock cycles associated with data transfer. For instance, the control module 340 may facilitate a faster clock domain for the generation of the data transfer requests or the transmission of the data transfer requests via one or more ports of the PE array 350. A port (also referred to as “host port” or “PE port”) may be associated with one or more PEs in the PE array 350. Also, a PE may be associated with one or more ports. The control module 340 may further facilitate a slower clock domain in the local memory 360.

In some embodiments, the control module 340 may support acceleration of computations by the PE array 350, e.g., based on sparsity in the input data of the computations. The control module 340 may have a sparsity acceleration logic that can identify non-zero-valued activation-weight pairs and skips zero-valued activation-weight pairs. A non-zero-valued activation-weight pair includes a non-zero-valued activation and a non-zero-valued weight, while a zero-valued activation-weight pair includes a zero-valued activation or a zero-valued weight. The control module 340 can detect sparsity in activations or weights. In situations where the sparsity module detects a zero-valued activation or weight, the control module 340 may prevent computation on the activation or weight. The control module 340 may also prevent the activation or weight from getting into the registers of the PE to reduce the number of gates switching in the PE.

In some embodiments, the control module 340 may support data reuse by the PE array 350. The control module 340 may instruct the PE to reuse at least some of the input operands from a computation round in the next computation round. In an example, the control module 340 may instruct, for a first round at a first time, a first multiplier in the PE to perform multiplication operations on a first input operand from a first input register file in the PE and a first weight operand from a first weight register file in the PE. For a second round at a second time, the control module 340 may instruct a second multiplier of the PE to perform multiplication operations on the first input operand and a second weight operand from a second weight register file, so that the first input operand is reused in both rounds within the PE. Additionally or alternatively, the control module 340 can facilitate data reuse across different PEs. For instance, the control module 340 may send same input operands and same weight operands to different PEs, which may perform MAC operations on the same data at the same time.

The PE array 350 may include PEs arranged in columns, or columns and rows. Each PE can perform MAC operations. In some embodiments, a PE includes one or more multipliers for performing multiplications. An PE may also include one or more accumulators (“adders”) for performing accumulations. A column of PEs is referred to as a PE column. A PE column may be associated with one or more MAC lanes. A MAC lane is a path for loading data into a MAC column. A MAC lane may be also referred to as a data transmission lane or data loading lane. A PE column may have multiple MAC lanes. The loading bandwidth of the MAC column is an aggregation of the loading bandwidths of all the MAC lanes associated with the MAC column. With a certain number of MAC lanes, data can be fed into the same number of independent PEs simultaneously. In some embodiments where a MAC column has four MAC lanes for feeding activations or weights into the MAC column and each MAC lane may have a bandwidth of 16 bytes, the four MAC lanes can have a total loading bandwidth of 64 bytes.

The PE array 350 may include one or more ports for communicating with the local memory 360. A PE port may be associated with one or more MAC lanes. Also, a MAC lane may be associated with one or more PE ports. A PE port may be controlled by one or more delivery units, such as ingress delivery unit, output delivery unit, etc. An ingress delivery unit may read data (e.g., input activation, weight, sparsity bitmap, etc.) from memory banks in the local memory 360. The ingress delivery unit may also format the data in a way that allows the PEs to process the data. An output delivery unit may receive data (e.g., output activation, etc.) from PEs and stores the data (and optionally, collateral data generated by the PEs) in the memory banks of the local memory 360. In some embodiments, a port may be in a clock domain that is faster than the clock domain of the memory banks. Usage of slower clock domain on memory bank side can reduce power footprint of the DNN accelerator 300. In some embodiments, multiple PEs ports can simultaneously access the same memory bank in the local memory 360, Arbiters are used to resolve contention.

In some embodiments, the PE array 350 may be capable of depthwise convolution, standard convolution, or both. In a depthwise convolution, a PE may perform an MAC operation that includes a sequence of multiplications for an input operand and a weight operand. Each multiplication in the sequence (also referred to as a cycle) is a multiplication of a different activation in the input operand with a different weight in the weight operand. The activation and weight in the same cycle may correspond to the same channel. The sequence of multiplication produces a product operand that includes a sequence of products. The MAC operation may also include accumulations in which multiple product operands are accumulated to produce an output operand of the PE. The PE array 350 may output multiple output operands at a time, each of which is generated by a different PE. In a standard convolution, MAC operations may include accumulations across the channels. For instance, as opposed to generating an output operand, a PE may accumulate products across different channels to generate a single output point.

In some embodiments, the PE array 350 may perform MAC operations in quantized inference, such as MAC operations in a quantized convolution. In some embodiments, a PE in the PE array 350 may receive quantized activation and quantized weights and compute a quantized MAC result. The quantized MAC result may be a quantized value in an integer format and may be the output of the PE. In some embodiments, the PE may also include a quantization multiplier that can multiply a quantization scale with the quantized MAC result, and the output of the PE may be a real value in a floating-point format. The PE may include no quantization subtractors as zero-point offsetting is not needed for the MAC operations in quantized inference.

The local memory 360 is local to the corresponding compute block 330. In the embodiments of FIG. 3, the local memory 360 is inside the compute block 330. In other embodiments, the local memory 360 may be outside the compute block 330. The local memory 360 and the PE array 350 can be implemented on the same chip. In some embodiments, the control module 340 may be implemented on the same chip too. The local memory 360 stores data used for or generated from deep learning operations. Examples of the data may include input activations, weights, output activations, sparsity bitmaps, and so on. In some embodiments, the local memory 360 includes one or more SRAMs. The local memory 360 may be byte-addressable, and each memory address identifies a single byte (eight bits) of storage.

In some embodiments, the local memory 360 may include memory banks. The number of data banks in the local memory 360 may be 16, 64, 128, 256, 512, 1024, 2048, or other numbers. A memory bank may include a plurality of storage units. In an example, a data bank may include 8, 16, 64, or a different number of storage units. A memory bank or a storage unit in a memory bank may have a memory address. In an example, a storage unit may store a single byte, and data larger than a single byte may be stored in storage units with consecutive memory addresses, i.e., adjacent storage units. For instance, a storage unit can store an integer number in the INT8 format, versus two storage units may be needed to store a number in the FP16 or BF16 format, which has 16 bits. In some embodiments, 16 bits can be transferred from the local memory 360 in a single read cycle. In other embodiments, 16 bits can be transferred from the local memory 360 in multiple read cycles, such as two cycles.

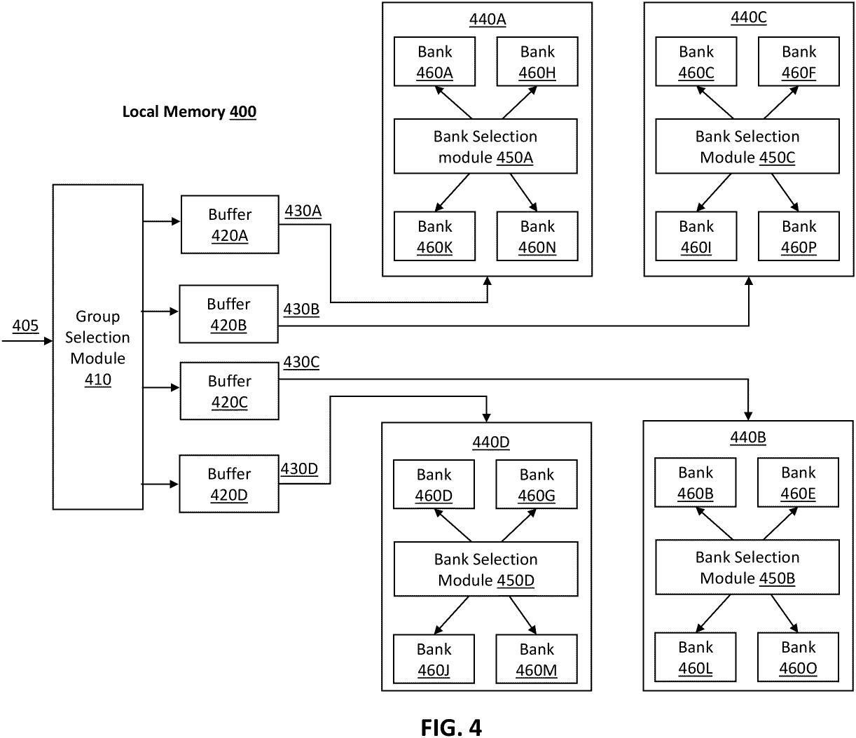

In some embodiments, the local memory 360 has a two-tier (or two-level) topology, where the memory banks are grouped into a plurality of bank groups. Each bank group may include a different subset of the memory banks. Each bank group may be coupled to a CDC component (e.g., a CDC FIFO buffer) through an interconnect. Data transfer requests may be pushed into (e.g., through read operations) the CDC components from one or more PE ports. A group selection module may process the data transfer requests beforehand to select which bank groups/interconnects to push the data transfer request into. The data transfer requests can be pulled out (e.g., through write operations) from the CDC components to enter the interconnects and arrive at the corresponding bank groups. Each bank group has a bank selection module that can select which memory banks to receive the data transfer requests based on memory addresses in the data transfer requests. PE ports and the group selection module may operate in accordance with faster clock cycles than the interconnects and the bank groups. The memory banks may be assigned to the banks groups in a manner that avoids two consecutive requests from being sent to the same bank group to improve the bandwidth utilization. More details regarding two-level topology of local memories are provided below in conjunction with FIGS. 4-7 and FIGS. 8A and 8B.

FIG. 4 illustrates an example request path in a local memory 400, in accordance with various embodiments. The local memory 400 may be a SRAM. The local memory 400 may be an embodiment of the local memory 360 in FIG. 3. In the embodiments of FIG. 4, the local memory 400 includes a group selection module 410, buffers 420A-420D (collectively referred to as “buffers 420” or “buffers 420”), interconnects 430A-430D (collectively referred to as “interconnects 430” or “interconnect 430”), and banks 460A-460P (collectively referred to as “banks 460” or “bank 460”) arranged in four bank groups 440A-440D ((collectively referred to as “bank groups 440” or “bank group 440”). In other embodiments, the local memory 400 may include different, fewer, or more components. For instance, the local memory 400 may include a different number of buffers, interconnects, banks, or bank groups.

The group selection module 410 is coupled to a host port 405. The host port 405 may be a port of a PE array (e.g., the PE array 350 in FIG. 3) for communicating with the local memory 400. The port may be used by one or more PEs in the PE array to make data transfer requests with the local memory 400. The request path may start when the group selection module 410 receives one or more data transfer requests from the host port 405. A data transfer request may be a read request for reading data from one or more of the banks 460 or a write request for writing data into one or more of the banks 460. In some embodiments, a data transfer request includes the address of the target bank. Even though FIG. 4 shows a single host port 405, the local memory 400 may be associated with more than one host port in other embodiments. The group selection module 410 may receive data transfer requests from multiple host ports in parallel.

The group selection module 410 may select which bank groups 440 the data transfer requests are to be transported to. In some embodiments, the group selection module 410 may include one or more demultiplexers that can be used to select bank groups 440. Each bank group 440 is associated with a buffer 420. A buffer 420 may be specific to a particular bank group 440. For instance, the bank group 440A is associated with the buffer 420A, the bank group 440B is associated with the buffer 420B, the bank group 440C is associated with the buffer 420C, and the bank group 440D is associated with the buffer 420D. Each buffer 420 is coupled with a bank group 440 through an interconnect 430. For instance, the interconnect 430A connects the buffer 420A to the bank group 440A, the interconnect 430B connects the buffer 420B to the bank group 440B, the interconnect 430C connects the buffer 420C to the bank group 440C, and the interconnect 430D connects the buffer 420D to the bank group 440D.

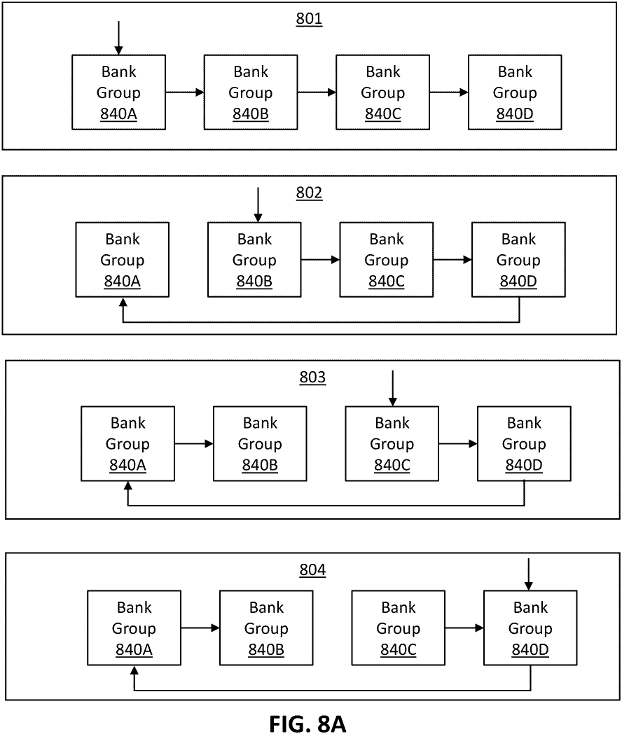

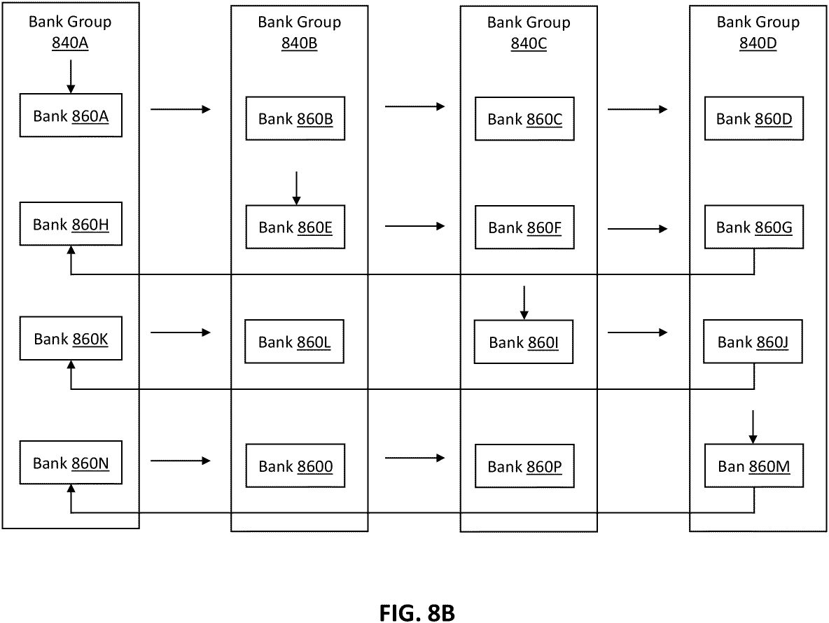

With the group selection module 410 and the buffers 420, multiple data transfer requests from the host port 405 can be transported in parallel into multiple bank groups 440 through the corresponding interconnects 430. For the purpose of illustration and simplicity, each bank group 440 in FIG. 4 includes a bank selection module 450A and four banks 460. Each bank may include an arbiter (not shown in FIG. 4). The arbiter may be used to decide which host port will be allowed to access the bank 460. An arbiter may arbitrate between multiple requests for access to the bank 460. An arbiter may receive multiple requests, e.g., from the bank selection module 450, for access to the bank 460 and then scheduling these requests, e.g., by determining the order in which requests should be granted. Even though FIG. 4 shows four bank groups 440 and 16 banks 460, the local memory 400 may include a different number of banks 460 that are arranged in a different number of bank groups 440 or arranged in the same number of bank groups 440 in a different way. More details regarding assignment of banks into bank groups are provided below in conjunction with FIG. 8.

After receiving a data transfer request, the group selection module 410 may select a bank group 440 and store the data transfer request in the corresponding buffer 420. The data transfer request (or information in the data transfer request, e.g., memory address in the data transfer request) may be retrieved from the buffer 420 associated with the selected bank group 440 and transmitted to the bank selection module 450 in the bank group 440. The memory address of the data transfer request may be decoded. After receiving the data transfer request (or information in the data transfer request), the bank selection module 450 may select a bank 460 in the bank group 440, e.g., based on the memory address, and direct the data transfer request to the selected bank 460. The data transfer request can be completed by reading data stored in the selected bank 460 or writing data into the selected bank 460.

The local memory 400 may have multiple clock domains. In some embodiments, the group selection module 410 may be in the same clock domain as the host port 405. The group selection module 410 and the host port 405 may be driven by the same clock. The interconnects 430 and bank groups 440 may be driven by a different clock and in a different clock domain from the group selection module 410 or the host port 405. The clock domain of the interconnects 430 and bank groups 440 may be slower (i.e., lower clock speed) than that of the group selection module 410 and the host port 405. In an example, a ratio of the clock speeds (also referred to as “clock rate”) of the two clock domains may be 2:1. The buffers 420 can support crossing from the faster clock domain to the slower clock domain. Each buffer 420 may be a CDC component. In some embodiments, each buffer 420 is a CDC FIFO buffer.

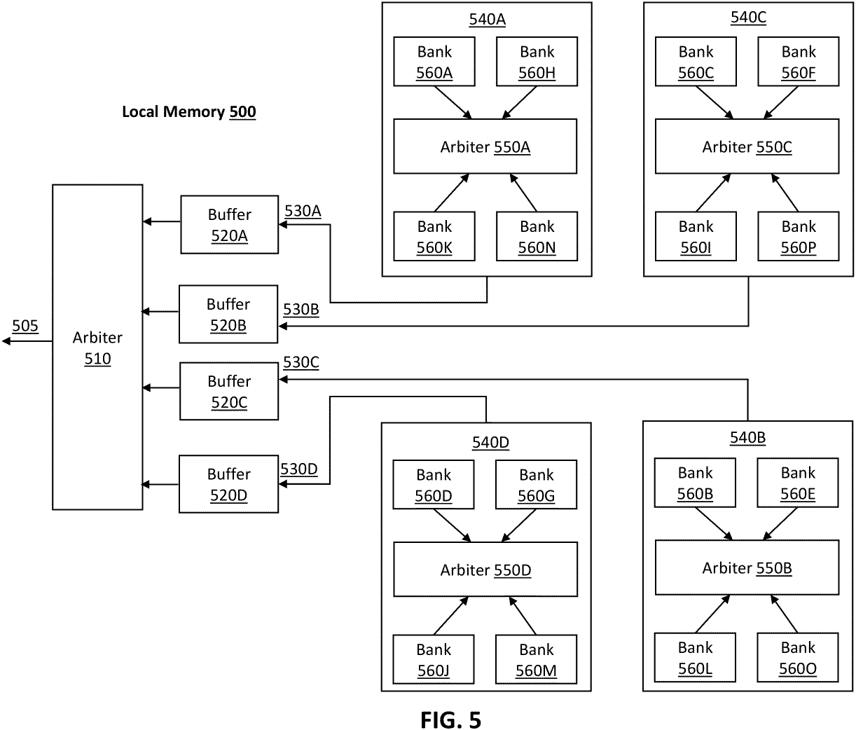

FIG. 5 illustrates an example response path in a local memory 500, in accordance with various embodiments. The local memory 500 may be a SRAM. The local memory 500 may be an embodiment of the local memory 360 in FIG. 3. In some embodiments, the local memory 500 and the local memory 400 in FIG. 4 may be the same memory. In the embodiments of FIG. 5, the local memory 500 includes an arbiter 510, buffers 520A-520D (collectively referred to as “buffers 520” or “buffers 520”), interconnects 530A-530D (collectively referred to as “interconnects 530” or “interconnect 530”), arbiters 550A-550D (collectively referred to as “arbiters 550” or “arbiter 550”), and banks 560A-560P (collectively referred to as “banks 560” or “bank 560”) arranged in four bank groups 540A-540D ((collectively referred to as “bank groups 540” or “bank group 540”). Each bank group 540 includes an arbiter 550 and four banks 560 coupled to the arbiter 550.

In other embodiments, the local memory 500 may include different, fewer, or more components. For example, the local memory 500 may include a different number of buffers, interconnects, banks, or bank groups. As another example, the local memory 500 may include a different number of banks 560 that are arranged in a different number of bank groups 540 or arranged in the same number of bank groups 540 in a different way.

The response path may start when one or more banks 560 provide responses to data transfer requests. A response to a data transfer request may include information indicating whether the data transfer request has been completed (e.g., data has been read from or written into a bank 560) or failed (e.g., data could not be read from or written into a bank 560). A bank 560 may transmit a response to the arbiter 550 of the bank group 540 including the bank 560. An arbiter 550 may arbitrate multiple responses from multiple banks 560 or from the same bank 560. The arbiter 550 can schedule these responses, e.g., by determining the order in which the responses should be processed or transmitted to the buffer 520 associated with the bank group 540. A response may be transmitted from an arbiter 550 to a buffer 520 through an interconnect 530.

Each bank group 540 is associated with a buffer 520. A buffer 520 may be specific to a particular bank group 540. For instance, the bank group 540A is associated with the buffer 520A, the bank group 540B is associated with the buffer 520B, the bank group 540C is associated with the buffer 520C, and the bank group 540D is associated with the buffer 520D. Each buffer 520 is coupled with a bank group 540 through an interconnect 530. For instance, the interconnect 530A connects the buffer 520A to the bank group 540A, the interconnect 530B connects the buffer 520B to the bank group 540B, the interconnect 530C connects the buffer 520C to the bank group 540C, and the interconnect 530D connects the buffer 520D to the bank group 540D.

Responses can be retrieved from the buffers 520 and transmitted to the arbiter 510. The arbiter 510 may arbitrate multiple responses from multiple buffers 520. The arbiter 510 can schedule these responses, e.g., by determining the order in which the responses should be transmitted to the host port 505. The host port 505 may be a port of a PE array (e.g., the PE array 350 in FIG. 3) for communicating with the local memory 500. The port may be used by one or more PEs in the PE array to make data transfer requests with the local memory 500. The response path for a data transfer request may end after the host port 505 receives the response indicating that the data transfer request has been completed or failed. With the arbiter 510 and the buffers 520, multiple responses from the bank groups 540 can be transported in parallel to the host port 505. Even though FIG. 5 shows a single host port 505, the local memory 500 may be associated with multiple host ports.

The local memory 500 may have multiple clock domains. In some embodiments, the arbiter 510 may be in the same clock domain as the host port 505. The arbiter 510 and the host port 505 may be driven by the same clock. The interconnects 530 and bank groups 540 may be driven by a different clock and in a different clock domain from the arbiter 510 or the host port 505. The clock domain of the interconnects 530 and bank groups 540 may be slower (i.e., lower clock speed) than that of the arbiter 510 and the host port 505. The buffers 520 can support crossing from the slower clock domain to the faster clock domain. Each buffer 520 may be a CDC component. In some embodiments, each buffer 520 is a CDC FIFO buffer.

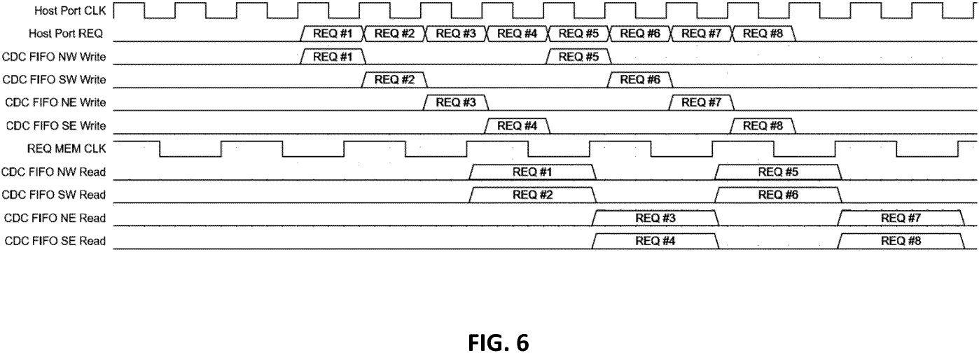

FIG. 6 illustrates clock cycles for a request path in a local memory, in accordance with various embodiments. The local memory in the embodiments of FIG. 6 may be an embodiment of the local memory 400 of FIG. 4. The request path may be an embodiment of the request path described above in conjunction with FIG. 4. There are two clock domains in the embodiments of FIG. 6: the first clock domain is represented by the clock for the host port (shown as “Host Port CLK” in FIG. 6), and the second clock domain is represented by the clock of the memory banks (shown as “REQ MEM CLK” in FIG. 6). The first clock domain has a higher frequency and is faster than the second clock domain. In other embodiments, there may be more than two clock domains.

The host port is in the first clock domain. In the embodiments of FIG. 6, the host port receives eight requests (REQ #1 through REQ #8). Each request is received by the host port in a single clock cycle. Next, the eight requests are written into four CDC FIFO buffers. Each CDC FIFO buffer may be an embodiment of the buffer 420 in FIG. 4. The eight requests are written in eight consecutive clock cycles in the first clock domain. The first request (REQ #1) and the fifth request (REQ #5) are written into a first CDC FIFO buffer (“CDC FIFO NW” in FIG. 6) in the first and fifth clock cycles of the eight clock cycles. The second request (REQ #2) and the fifth request (REQ #6) are written into a second CDC FIFO buffer (“CDC FIFO SW” in FIG. 6) in the second and sixth clock cycles of the eight clock cycles. The third request (REQ #3) and the seventh request (REQ #7) are written into a third CDC FIFO buffer (“CDC FIFO NE” in FIG. 6) in the third and seventh clock cycles of the eight clock cycles. The fourth request (REQ #4) and the eighth request (REQ #8) are written into a fourth CDC FIFO buffer (“CDC FIFO SE” in FIG. 6) in the fourth and eighth clock cycles of the eight clock cycles.

Reading the requests from the CDC FIFO buffers follows the clock cycles of the slower clock domain. Four clock cycles are used for reading the eight requests from the CDC FIFO buffers. As shown in FIG. 6, the first request (REQ #1) and the fifth request (REQ #5) are read from the first CDC FIFO buffer (“CDC FIFO NW” in FIG. 6) in the first and third clock cycles of the four clock cycles. The second request (REQ #2) and the fifth request (REQ #6) are read from the second CDC FIFO buffer (“CDC FIFO SW” in FIG. 6) in the first and third clock cycles of the four clock cycles. The third request (REQ #3) and the seventh request (REQ #7) are read from the third CDC FIFO buffer (“CDC FIFO NE” in FIG. 6) in the second and fourth clock cycles of the four clock cycles. The fourth request (REQ #4) and the eighth request (REQ #8) are read from the fourth CDC FIFO buffer (“CDC FIFO SE” in FIG. 6) in the second and fourth clock cycles of the four clock cycles.

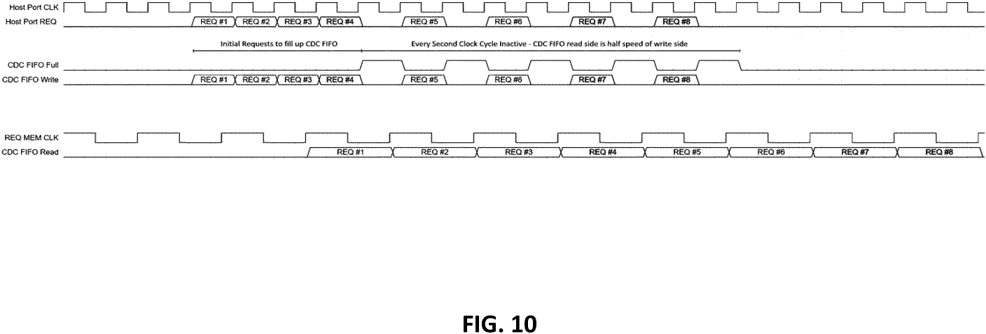

With the multiple CDC FIFO buffers, the bandwidth utilization can reach 100% in the embodiments of FIG. 6. As described above, consecutive requests can be pushed and pulled into different bank groups that are coupled to the different CDC FIFO buffers. The multi-bank group design of the local memory can avoid scenarios where CDC FIFO becomes full, and backpressure the host port. An example of such scenarios is described below in conjunction with FIG. 10.

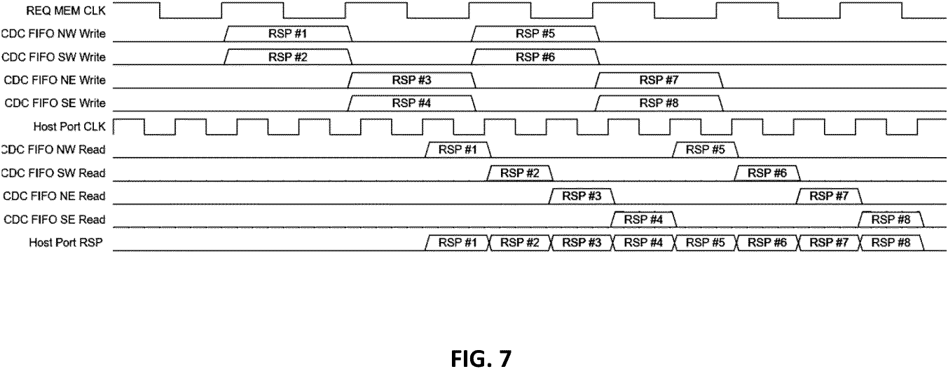

FIG. 7 illustrates clock cycles for a response path in a local memory, in accordance with various embodiments. The local memory in the embodiments of FIG. 7 may be an embodiment of the local memory 500 of FIG. 5. The response path may be an embodiment of the response path described above in conjunction with FIG. 5. There are two clock domains in the embodiments of FIG. 7: the first clock domain is represented by the clock of the memory banks (shown as “REQ MEM CLK” in FIG. 7), and the second clock domain is represented by the clock for the host port (shown as “Host Port CLK” in FIG. 7). The first clock domain has a lower frequency and is slower than the second clock domain. In other embodiments, there may be more than two clock domains.

Eight responses (RSP #1 through RSP #8) are written into four CDC FIFO buffers following the clock cycles of the first clock domain. Each CDC FIFO buffer may be an embodiment of the buffer 520 in FIG. 5. Four clock cycles are used for writing the eight requests into the CDC FIFO buffers. As shown in FIG. 7, the first response (RSP #1) and the fifth response (RSP #5) are written into a first CDC FIFO buffer (“CDC FIFO NW” in FIG. 7) in the first and third clock cycles of the four clock cycles. The second response (RSP #2) and the fifth response (RSP #6) are written into a second CDC FIFO buffer (“CDC FIFO SW” in FIG. 7) in the first and third clock cycles of the four clock cycles. The third response (RSP #3) and the seventh response (RSP #7) are written into a third CDC FIFO buffer (“CDC FIFO NE” in FIG. 7) in the second and fourth clock cycles of the four clock cycles. The fourth response (RSP #4) and the eighth response (RSP #8) are written into a fourth CDC FIFO buffer (“CDC FIFO SE” in FIG. 7) in the second and fourth clock cycles of the four clock cycles.

Reading the responses from the CDC FIFO buffers follow the clock cycles of the second clock domain. The eight responses are read within eight consecutive clock cycles. The first response (RSP #1) and the fifth response (RSP #5) are read from the first CDC FIFO buffer (“CDC FIFO NW” in FIG. 7) in the first and fifth clock cycles of the eight clock cycles. The second response (RSP #2) and the fifth response (RSP #6) are read from the second CDC FIFO buffer (“CDC FIFO SW” in FIG. 7) in the second and sixth clock cycles of the eight clock cycles. The third response (RSP #3) and the seventh response (RSP #7) are read from the third CDC FIFO buffer (“CDC FIFO NE” in FIG. 7) in the third and seventh clock cycles of the eight clock cycles. The fourth response (RSP #4) and the eighth response (RSP #8) are read from the fourth CDC FIFO buffer (“CDC FIFO SE” in FIG. 7) in the fourth and eighth clock cycles of the eight clock cycles.

The host port associated with the local memory receives the eight responses from the CDC FIFO buffers. As shown in FIG. 7, the host port receives each response in the cycle when the response is read from the CDC FIFO. With the multiple CDC FIFO buffers, the bandwidth utilization reaches 100% in the embodiments of FIG. 7.

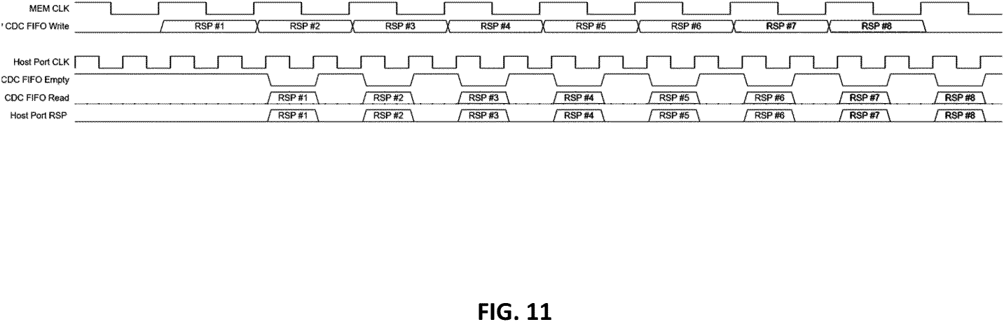

With the multiple CDC FIFO buffers, the bandwidth utilization can reach 100% in the embodiments of FIG. 7. As described above, consecutive responses can be pulled in parallel from different bank groups that are coupled to the different CDC FIFO buffers. Transactions from multiple bank groups may flow simultaneously back to the host port. As, read is done by PEs port which utilizes the faster clock domain, no excessive CDC FIFO fill or backpressure can be observed. The multi-bank group design of the local memory can avoid scenarios where CDC FIFO becomes full, and backpressure the host port. An example of such scenarios is described below in conjunction with FIG. 11.

FIGS. 8A and 8B illustrate a process of assigning banks 860A-860P to bank groups 840A-840D, in accordance with various embodiments. The banks 860A-860P may be in a local memory of a compute block in a DNN accelerator, such as the local memory 360 in FIG. 3, the local memory 400 in FIG. 4, or the local memory 500 in FIG. 5. The banks 860A-860P are collectively referred to as “banks 860” or “bank 860.” The bank groups 840A-840D are collectively referred to as “bank groups 840” or “bank group 840.” A bank 860 may be an embodiment of a bank 460 in FIG. 4 or bank 560 in FIG. 5. A bank group 840 may be an embodiment of a bank group 440 in FIG. 4 or bank group 540 in FIG. 5. For the purpose of illustration, FIGS. 8A and 8B show four bank groups 840 and 16 banks 860. In other embodiments, there may be a different number of bank groups or banks.

FIG. 8A shows four rounds 801-804 of assignment. The round 801 starts with bank group 840A, followed by the bank group 840B, then the bank group 840C, and ends with the bank group 840D. The round 802 starts with bank group 840B, followed by the bank group 840C, then the bank group 840D, and ends with the bank group 840A. The round 803 starts with bank group 840C, followed by the bank group 840D, then the bank group 840A, and ends with the bank group 840B. The round 804 starts with bank group 840D, followed by the bank group 840A, then the bank group 840B, and ends with the bank group 840C.

The number of bank groups may be determined based on the number of banks. For N banks, M bank groups may be used:

$$M = f l o o r \left(N\right) + \left(N \% 4\right)$$

where floor denotes the floor function that takes as input a real number, and gives as output the greatest integer less than or equal to the real number, and % denotes the modulo operation returns the remainder or signed remainder of a division after one number is divided by another.

FIG. 8B illustrates the grouping of the banks 460.The banks 460 may be assigned to the bank groups 440 in a manner that consecutive requests from a host port are not targeting the same bank group as the DNN accelerator can still bounded by the slower pull speed from CDC FIFO. The banks 460 may be grouped to minimize same group back-to-back accesses. In some embodiments, delivery units of the PEs associated with the host port may generate stream of requests with distance between consecutive accesses being power of two number times memory data width (i.e., 2^{x} _{*} 32B). The banks 460 may be assigned into the bank groups 840 to ensure banks inside group are distance from each by value different then power of two.

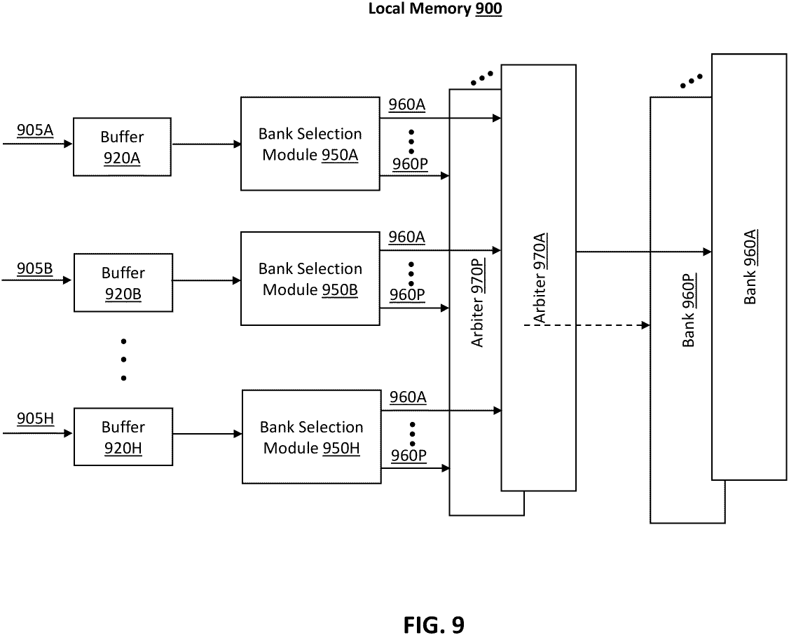

FIG. 9 illustrates an example local memory 900 with one-level topology, in accordance with various embodiments. The local memory 900 may be a SRAM. The local memory 900 is associated with eight host ports 905A-905H (collectively referred to as “host ports 905” or “host port 905”). Each host port 905 may be associated with one or more PEs. The local memory 900 includes eight buffers 920A-920H (collectively referred to as “buffers 920” or “buffers 920”), bank selection modules 950A-950H (collectively referred to as “bank selection modules 950” or “bank selection module 950”), 16 banks 960A-960P (collectively referred to as “banks 960” or “bank 960”), and arbiters 970A-970P (individually referred to as “arbiter 970”). In other embodiments, the local memory 900 may include different, fewer, or more components.

The buffer to bank ratio in the local memory 900 is 1:2. The buffers 920 may be in a faster clock domain. The bank selection groups 950, the banks 960, and the arbiters 970 are in a slower clock domain. For data transfer requests received through the host ports 905, the write speed (i.e., the speed to write data into the buffers 920) is faster than the read speed (i.e., the speed to read data from the buffers 920). The memory bandwidth can be limited by read speed (slower clock). In some embodiments, every other clock on host port side would be dead or inactive. In an example, at most eight paths or banks are active at each clock cycle. The bandwidth utilization may be approximately 50%, e.g., in embodiments where the clock ratio of the two clock domains is 2:1.

Comparing the local memory 900 with the local memory 400 or the local memory 500, the same number of arbiters may be used, but the local memory 900 may need eight 1:16 demultiplexers for bank selection while the local memory 400 may use 32 1:4 demultiplexers for both group selection and bank section. Also, the local memory 400 may use more buffers than the local memory 900. For instance, the local memory 400 may use 32 buffers while the local memory 900 may use eight buffers. The number of interconnects in the local memory 400 and the local memory 900 may be the same. In an example, the number of interconnects may be 128.

Even though the local memory 400 or 500 can provide much better bandwidth utilization than the local memory 900, the local memory 400 or 500 does not consume more area. The number of interconnects in the local memory 400 or 500 is the same as the local memory 900. The local memory 400 or 500 also does not require significantly more area for demultiplexers, as a single 1:16 demultiplexer has a similar area cost as four 1:4 demultiplexers. Further, increasing the number of CDC FIFOs would not cause the silicon floorplan area to increase, as interconnect fabric silicon utilization is usually low as those circuits are heavy on wires/links and not logic cells.

FIG. 10 illustrates clock cycles for a request path in the local memory 900 in FIG. 9, in accordance with various embodiments. After the initial burst of requests (REQ #1 through REQ #4), the CDC FIFO becomes full, and backpressure is applied. The PE(s) is stalled from sending any more requests. The backpressure is applied because the receiving side that is pulling requests from the CDC FIFO is running on a slower clock and is not able to keep up with fast running PE ports. This backpressure forces them to eventually slow down to the rate at which the requests are being pulled out by the receiving side of the interconnect. A similar performance bottleneck and drop in bandwidth utilization is seen on the response side.

FIG. 11 illustrates clock cycles for a response path in the local memory of FIG. 9, in accordance with various embodiments. Host ports are capable to pulling responses at a rate twice as fast as the interconnect is able push them into the CDC FIFOs, resulting in 50% of the time the CDC FIFO idling as empty, e.g., in embodiments where the clock ratio of the two clock domains is 2:1. The interconnect and the flat memory bank topology are unable to achieve full utilization of the provisioned bandwidth due to the CDC crossing resulting in a performance degradation, which further impact memory bound DNN-based applications.

### Example PE

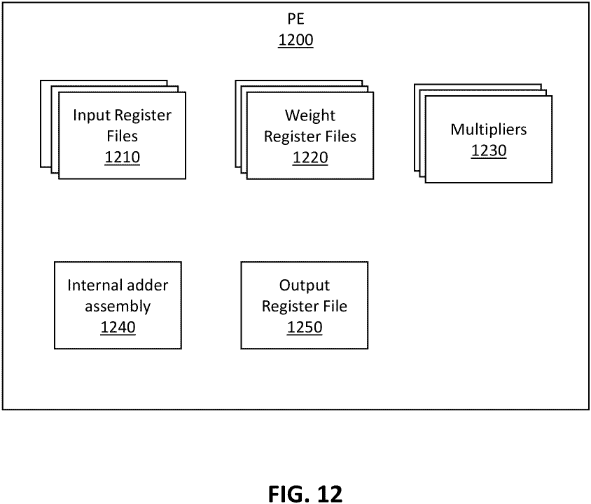

FIG. 12 is a block diagram of a PE 1200, in accordance with various embodiments. The PE 1200 may perform MAC operations, e.g., MAC operations using data in integer formats. The PE 1200 may be an example PE in the PE array 350 described above in conjunction with FIG. 3. As shown in FIG. 12, the PE 1200 includes input register files 1210 (individually referred to as “input register file 1210”), weight registers file 1220 (individually referred to as “weight register file 1220”), multipliers 1230 (individually referred to as “multiplier 1230”), an internal adder assembly 1240, and an output register file 1250. In other embodiments, the PE 1200 may include fewer, more, or different components. For example, the PE 1200 may include multiple output register files 1250. As another example, the PE 1200 may include a single input register file 1210, weight register file 1220, or multiplier 1230. As yet another example, the PE 1200 may include an adder in lieu of the internal adder assembly 1240.

The input register files 1210 temporarily store activation operands for MAC operations by the PE 1200. In some embodiments, an input register file 1210 may store a single activation operand at a time. In other embodiments, an input register file 1210 may store multiple activation operand or a portion of an activation operand at a time. An activation operand includes a plurality of input elements (i.e., input elements) in an input tensor. The input elements of an activation operand may be stored sequentially in the input register file 1210 so the input elements can be processed sequentially. In some embodiments, each input element in the activation operand may be from a different input channel of the input tensor. The activation operand may include an input element from each of the input channels of the input tensor, and the number of input elements in an activation operand may equal the number of the input channels. The input elements in an activation operand may have the same XY coordinates, which may be used as the XY coordinates of the activation operand. For instance, all the input elements of an activation operand may be X0Y0, X0Y1, X1Y1, etc.

The weight register file 1220 temporarily stores weight operands for MAC operations by the PE 1200. The weight operands include weights in the filters of the DNN layer. In some embodiments, the weight register file 1220 may store a single weight operand at a time. other embodiments, an input register file 1210 may store multiple weight operands or a portion of a weight operand at a time. A weight operand may include a plurality of weights. The weights of a weight operand may be stored sequentially in the weight register file 1220 so the weight can be processed sequentially. In some embodiments, for a multiplication operation that involves a weight operand and an activation operand, each weight in the weight operand may correspond to an input element of the activation operand. The number of weights in the weight operand may equal the number of the input elements in the activation operand.

In some embodiments, a weight register file 1220 may be the same or similar as an input register file 1210, e.g., having the same size, etc. The PE 1200 may include a plurality of register files, some of which are designated as the input register files 1210 for storing activation operands, some of which are designated as the weight register files 1220 for storing weight operands, and some of which are designated as the output register file 1250 for storing output operands. In other embodiments, register files in the PE 1200 may be designated for other purposes, e.g., for storing scale operands used in elementwise add operations, etc.

The multipliers 1230 perform multiplication operations on activation operands and weight operands. A multiplier 1230 may perform a sequence of multiplication operations on a single activation operand and a single weight operand and generate a product operand including a sequence of products. Each multiplication operation in the sequence includes multiplying an input element in the activation operand and a weight in the weight operand. In some embodiments, a position (or index) of the input element in the activation operand matches the position (or index) of the weight in the weight operand. For instance, the first multiplication operation is a multiplication of the first input element in the activation operand and the first weight in the weight operand, the second multiplication operation is a multiplication of the second input element in the activation operand and the second weight in the weight operand, the third multiplication operation is a multiplication of the third input element in the activation operand and the third weight in the weight operand, and so on. The input element and weight in the same multiplication operation may correspond to the same depthwise channel, and their product may also correspond to the same depthwise channel.

Multiple multipliers 1230 may perform multiplication operations simultaneously. These multiplication operations may be referred to as a round of multiplication operations. In a round of multiplication operations by the multipliers 1230, each of the multipliers 1230 may use a different activation operand and a different weight operand. The different activation operands or weight operands may be stored in different register files of the PE 1200. For instance, a first multiplier 1230 uses a first activation operand (e.g., stored in a first input register file 1210) and a first weight operand (e.g., stored in a first weight register file 1220), versus a second multiplier 1230 uses a second activation operand (e.g., stored in a second input register file 1210) and a second weight operand (e.g., stored in a second weight register file 1220), a third multiplier 1230 uses a third activation operand (e.g., stored in a third input register file 1210) and a third weight operand (e.g., stored in a third weight register file 1220), and so on. For an individual multiplier 1230, the round of multiplication operations may include a plurality of cycles. A cycle includes a multiplication operation on an input element and a weight.

The multipliers 1230 may perform multiple rounds of multiplication operations. A multiplier 1230 may use the same weight operand but different activation operands in different rounds. For instance, the multiplier 1230 performs a sequence of multiplication operations on a first activation operand stored in a first input register file in a first round, versus a second activation operand stored in a second input register file in a second round. In the second round, a different multiplier 1230 may use the first activation operand and a different weight operand to perform another sequence of multiplication operations. That way, the first activation operand is reused in the second round. The first activation operand may be further reused in additional rounds, e.g., by additional multipliers 1230.

The internal adder assembly 1240 includes one or more adders inside the PE 1200, i.e., internal adders. The internal adder assembly 1240 may perform accumulation operations on two or more products operands from multipliers 1230 and produce an output operand of the PE 1200. In some embodiments, the internal adders are arranged in a sequence of tiers. A tier includes one or more internal adders. For the first tier of the internal adder assembly 1240, an internal adder may receive product operands from two or more multipliers 1230 and generate a sum operand through a sequence of accumulation operations. Each accumulation operation produces a sum of two or more products, each of which is from a different multiplier 1230. The sum operand includes a sequence of sums, each of which is a result of an accumulation operation and corresponds to a depthwise channel. For the other tier(s) of the internal adder assembly 1240, an internal adder in a tier receives sum operands from the precedent tier in the sequence. Each of these numbers may be generated by a different internal adder in the precedent tier. A ratio of the number of internal adders in a tier to the number of internal adders in a subsequent tier may be 2:1. In some embodiments, the last tier of the internal adder assembly 1240 may include a single internal adder, which produces the output operand of the PE 1200.

The output register file 1250 stores output operands of the PE 1200. In some embodiments, the output register file 1250 may store an output operand at a time. In other embodiments, the output register file 1250 may store multiple output operands or a portion of an output operand at a time. An output operand includes a plurality of output elements in an IFM. The output elements of an output operand may be stored sequentially in the output register file 1250 so the output elements can be processed sequentially. In some embodiments, each output element in the output operand corresponds to a different depthwise channel and is an element of a different output channel of the output channel of the depthwise convolution. The number of output elements in an output operand may equal the number of the depthwise channels of the depthwise convolution.

### Example PE Array

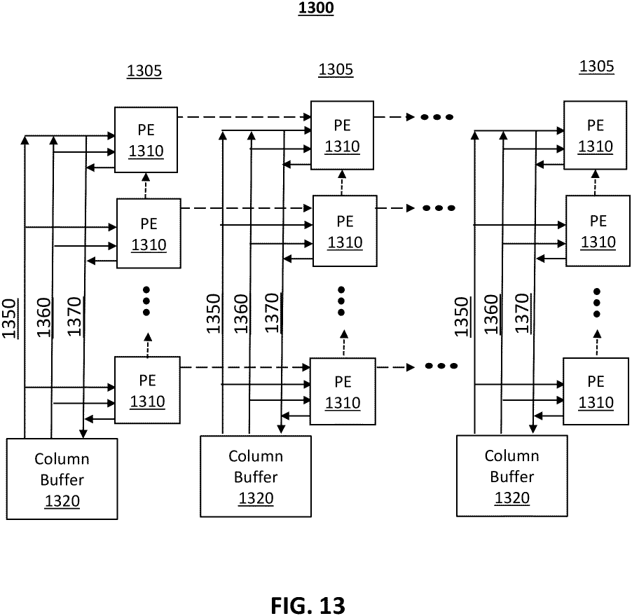

FIG. 13 illustrates a PE array, in accordance with various embodiments. The PE array 1300 may be an embodiment of the PE array 350 in FIG. 3. The PE array 1300 includes a plurality of PEs 1310 (individually referred to as “PE 1310”). An embodiment of a PE 1310 may be the PE 1200 in FIG. 12. The PEs 1310 can perform MAC operations, including MAC operations in quantized inference. The PEs 1310 may also be referred to as neurons in the DNN. Each PE 1310 has two input signals 1350 and 1360 and an output signal 1370. The input signal 1350 is at least a portion of an IFM to the layer. The input signal 1360 is at least a portion of a filter of the layer. In some embodiments, the input signal 1350 of a PE 1310 includes one or more input operands, and the input signal 1360 includes one or more weight operands.

Each PE 1310 performs an MAC operation on the input signals 1350 and 1360 and outputs the output signal 1370, which is a result of the MAC operation. Some or all of the input signals 1350 and 1360 and the output signal 1370 may be in an integer format, such as INT8, or floating-point format, such as FP16 or BF16. For the purpose of simplicity and illustration, the input signals and output signal of all the PEs 1310 have the same reference numbers, but the PEs 1310 may receive different input signals and output different output signals from each other. Also, a PE 1310 may be different from another PE 1310, e.g., including more, fewer, or different components.

As shown in FIG. 13, the PEs 1310 are connected to each other, as indicated by the dash arrows in FIG. 13. The output signal 1370 of an PE 1310 may be sent to many other PEs 1310 (and possibly back to itself) as input signals via the interconnections between PEs 1310. In some embodiments, the output signal 1370 of an PE 1310 may incorporate the output signals of one or more other PEs 1310 through an accumulate operation of the PE 1310 and generates an internal partial sum of the PE array.

In the embodiments of FIG. 13, the PEs 1310 are arranged into columns 1305 (individually referred to as “column 1305”). The input and weights of the layer may be distributed to the PEs 1310 based on the columns 1305. Each column 1305 has a column buffer 1320. The column buffer 1320 stores data provided to the PEs 1310 in the column 1305 for a short amount of time. The column buffer 1320 may also store data output by the last PE 1310 in the column 1305. The output of the last PE 1310 may be a sum of the MAC operations of all the PEs 1310 in the column 1305, which is a column-level internal partial sum of the PE array 1300. In other embodiments, input and weights may be distributed to the PEs 1310 based on rows in the PE array 1300. The PE array 1300 may include row buffers in lieu of column buffers 1320. A row buffer may store input signals of the PEs in the corresponding row and may also store a row-level internal partial sum of the PE array 1300.

In some embodiments, a column buffer 1320 may be a portion of the local memory 360 in FIG. 3. The column buffer 1320 may be associated with upper memory hierarchies, e.g., the memory 310 in FIG. 3. Data in the column buffer 1320 may be sent to the upper memory hierarchies. The column buffer 1320 may receive data from the upper memory hierarchies.

### Example Method of Data Transfer for Deep Learning

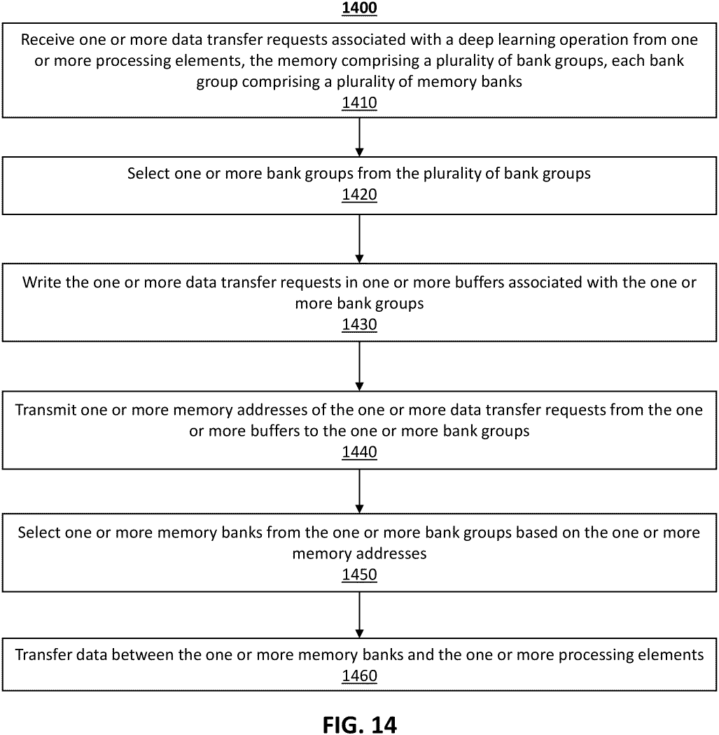

FIG. 14 is a flowchart showing a method 1400 of data transfer for deep learning operations, in accordance with various embodiments. The method 1400 may be performed by the local memory 360 in FIG. 3. Although the method 1400 is described with reference to the flowchart illustrated in FIG. 14, many other methods for data transfer for deep learning operations may alternatively be used. For example, the order of execution of the steps in FIG. 14 may be changed. As another example, some of the steps may be changed, eliminated, or combined.

The local memory 360 receives 1410 one or more data transfer requests associated with a deep learning operation from one or more PEs. The local memory 360 comprises a plurality of bank groups. Each bank group comprising a plurality of memory banks. In some embodiments, the one or more PEs are in a first clock domain. The plurality of bank groups is in a second clock domain. The first clock domain is faster than the second clock domain. In some embodiments, each data transfer request comprises a request to read input data of a deep learning operation to be performed by a PE from the memory or a request to write output data of a deep learning operation performed by a PE into the memory.

The local memory 360 selects 1420 one or more bank groups from the plurality of bank groups. In some embodiments, the local memory 360 selects two different bank groups for two consecutive requests. The two consecutive requests may be two requests received by the local memory 360 consecutively, i.e., without another request in between.

The local memory 360 writes 1430 the one or more data transfer requests in one or more buffers associated with the one or more bank groups. The one or more buffers comprises a clock domain crossing buffer. Each buffer may be associated with a different one of the bank groups.

The local memory 360 transmits 1440 one or more memory addresses of the one or more data transfer requests from the one or more buffers to the one or more bank groups. In some embodiments, the local memory 360 transmits the one or more memory addresses through one or more interconnects, each interconnect coupling one of the one or more buffers to one of the one or more bank groups. In some embodiments, the one or more PEs are in a first clock domain. The plurality of bank groups and the one or more interconnects are in a second clock domain. The first clock domain is faster than the second clock domain.

The local memory 360 selects 1450 one or more memory banks from the one or more bank groups based on the one or more memory addresses. In some embodiments, the one or more memory addresses may be decoded after the one or more data transfer requests are read from the one or more buffers.

The local memory 360 transfers 1460 data between the one or more memory banks and the one or more PEs. For example, the data may be read from the one or more memory banks. As another example, the data may be written into the one or more memory banks.

### Example Computing Device

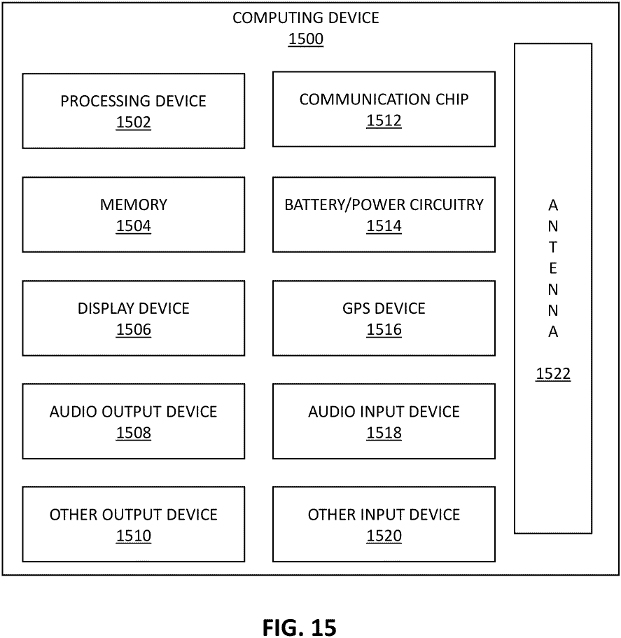

FIG. 15 is a block diagram of an example computing device 1500, in accordance with various embodiments. In some embodiments, the computing device 1500 can be used as at least part of the DNN accelerator 300. A number of components are illustrated in FIG. 15 as included in the computing device 1500, but any one or more of these components may be omitted or duplicated, as suitable for the application. In some embodiments, some or all of the components included in the computing device 1500 may be attached to one or more motherboards. In some embodiments, some or all of these components are fabricated onto a single system on a chip (SoC) die. Additionally, in various embodiments, the computing device 1500 may not include one or more of the components illustrated in FIG. 15, but the computing device 1500 may include interface circuitry for coupling to the one or more components. For example, the computing device 1500 may not include a display device 1506, but may include display device interface circuitry (e.g., a connector and driver circuitry) to which a display device 1506 may be coupled. In another set of examples, the computing device 1500 may not include an audio input device 1518 or an audio output device 1508, but may include audio input or output device interface circuitry (e.g., connectors and supporting circuitry) to which an audio input device 1518 or audio output device 1508 may be coupled.

The computing device 1500 may include a processing device 1502 (e.g., one or more processing devices). The processing device 1502 processes electronic data from registers and/or memory to transform that electronic data into other electronic data that may be stored in registers and/or memory. The computing device 1500 may include a memory 1504, which may itself include one or more memory devices such as volatile memory (e.g., DRAM), nonvolatile memory (e.g., read-only memory (ROM)), high bandwidth memory (HBM), flash memory, solid state memory, and/or a hard drive. In some embodiments, the memory 1504 may include memory that shares a die with the processing device 1502. In some embodiments, the memory 1504 includes one or more non-transitory computer-readable media storing instructions executable to perform operations for data transfer for deep learning, e.g., the method 1400 described above in conjunction with FIG. 14 or some operations performed by the DNN accelerator 300 (e.g., the local memory 360) described above in conjunction with FIG. 3, the local memory 400 described above in conjunction with FIG. 4, or the local memory 500 described above in conjunction with FIG. 5. The instructions stored in the one or more non-transitory computer-readable media may be executed by the processing device 1502.

In some embodiments, the computing device 1500 may include a communication chip 1512 (e.g., one or more communication chips). For example, the communication chip 1512 may be configured for managing wireless communications for the transfer of data to and from the computing device 1500. The term “wireless” and its derivatives may be used to describe circuits, devices, systems, methods, techniques, communications channels, etc., that may communicate data through the use of modulated electromagnetic radiation through a nonsolid medium. The term does not imply that the associated devices do not contain any wires, although in some embodiments they might not.

The communication chip 1512 may implement any of a number of wireless standards or protocols, including but not limited to Institute for Electrical and Electronic Engineers (IEEE) standards including Wi-Fi (IEEE 802.10 family), IEEE 802.16 standards (e.g., IEEE 802.16-2005 Amendment), Long-Term Evolution (LTE) project along with any amendments, updates, and/or revisions (e.g., advanced LTE project, ultramobile broadband (UMB) project (also referred to as “3GPP2”), etc.). IEEE 802.16 compatible Broadband Wireless Access (BWA) networks are generally referred to as WiMAX networks, an acronym that stands for worldwide interoperability for microwave access, which is a certification mark for products that pass conformity and interoperability tests for the IEEE 802.16 standards. The communication chip 1512 may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. The communication chip 1512 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication chip 1512 may operate in accordance with Code-division Multiple Access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. The communication chip 1512 may operate in accordance with other wireless protocols in other embodiments. The computing device 1500 may include an antenna 1522 to facilitate wireless communications and/or to receive other wireless communications (such as AM or FM radio transmissions).

In some embodiments, the communication chip 1512 may manage wired communications, such as electrical, optical, or any other suitable communication protocols (e.g., the Ethernet). As noted above, the communication chip 1512 may include multiple communication chips. For instance, a first communication chip 1512 may be dedicated to shorter-range wireless communications such as Wi-Fi or Bluetooth, and a second communication chip 1512 may be dedicated to longer-range wireless communications such as global positioning system (GPS), EDGE, GPRS, CDMA, WiMAX, LTE, EV-DO, or others. In some embodiments, a first communication chip 1512 may be dedicated to wireless communications, and a second communication chip 1512 may be dedicated to wired communications.

The computing device 1500 may include battery/power circuitry 1514. The battery/power circuitry 1514 may include one or more energy storage devices (e.g., batteries or capacitors) and/or circuitry for coupling components of the computing device 1500 to an energy source separate from the computing device 1500 (e.g., AC line power).

The computing device 1500 may include a display device 1506 (or corresponding interface circuitry, as discussed above). The display device 1506 may include any visual indicators, such as a heads-up display, a computer monitor, a projector, a touchscreen display, a liquid crystal display (LCD), a light-emitting diode display, or a flat panel display, for example.

The computing device 1500 may include an audio output device 1508 (or corresponding interface circuitry, as discussed above). The audio output device 1508 may include any device that generates an audible indicator, such as speakers, headsets, or earbuds, for example.

The computing device 1500 may include an audio input device 1518 (or corresponding interface circuitry, as discussed above). The audio input device 1518 may include any device that generates a signal representative of a sound, such as microphones, microphone arrays, or digital instruments (e.g., instruments having a musical instrument digital interface (MIDI) output).

The computing device 1500 may include a GPS device 1516 (or corresponding interface circuitry, as discussed above). The GPS device 1516 may be in communication with a satellite-based system and may receive a location of the computing device 1500, as known in the art.

The computing device 1500 may include another output device 1510 (or corresponding interface circuitry, as discussed above). Examples of the other output device 1510 may include an audio codec, a video codec, a printer, a wired or wireless transmitter for providing information to other devices, or an additional storage device.

The computing device 1500 may include another input device 1520 (or corresponding interface circuitry, as discussed above). Examples of the other input device 1520 may include an accelerometer, a gyroscope, a compass, an image capture device, a keyboard, a cursor control device such as a mouse, a stylus, a touchpad, a bar code reader, a Quick Response (QR) code reader, any sensor, or a radio frequency identification (RFID) reader.

The computing device 1500 may have any desired form factor, such as a handheld or mobile computer system (e.g., a cell phone, a smart phone, a mobile internet device, a music player, a tablet computer, a laptop computer, a netbook computer, an ultrabook computer, a personal digital assistant (PDA), an ultramobile personal computer, etc.), a desktop computer system, a server or other networked computing component, a printer, a scanner, a monitor, a set-top box, an entertainment control unit, a vehicle control unit, a digital camera, a digital video recorder, or a wearable computer system. In some embodiments, the computing device 1500 may be any other electronic device that processes data.

### Select Examples

The following paragraphs provide various examples of the embodiments disclosed herein.

Example 1 provides a memory device for a deep learning operation, the memory device including a plurality of bank groups, a bank group including one or more memory banks in the memory device; a plurality of buffers, each buffer associated with a different bank group of the plurality of bank groups; a group selection module configured to receive one or more data transfer requests associated with a deep learning operation, select one or more bank groups from the plurality of bank groups, and write the one or more data transfer requests in one or more buffers associated with the one or more bank groups; and a plurality of bank selection modules, a bank selection module associated with a bank group and configured to receive a memory address of a data transfer request stored in a buffer associated with the bank group and to select a memory bank from the bank group based on the memory address.

Example 2 provides the memory device of example 1, where the group selection module is in a first clock domain, the plurality of bank selection modules is in a second clock domain that is slower than the first clock domain.

Example 3 provides the memory device of example 2, where the plurality of buffers includes a clock domain crossing buffer.

Example 4 provides the memory device of any of the preceding examples, further including a plurality of interconnects, each interconnect coupling a corresponding bank group to a corresponding buffer associated with the corresponding bank group for transferring data from the corresponding buffer to the corresponding bank group.

Example 5 provides the memory device of example 4, where the group selection module is in a first clock domain, and the plurality of interconnects, the plurality of bank selection modules, or the plurality of bank groups is in a second clock domain that is slower than the first clock domain.

Example 6 provides the memory device of any of the preceding examples, where a first bank selection module is configured to receive an address of a first data transfer task in a first clock cycle, a second bank selection module is configured to receive an address of a second data transfer task in a second clock cycle, and the second clock cycle is immediately after the first clock cycle.

Example 7 provides the memory device of example 6, where the group selection module or a bank selection module includes a demultiplexer.

Example 8 provides an apparatus for a deep learning operation, the apparatus including one or more processing elements configured to perform the deep learning operation; and a memory including: a plurality of bank groups, a bank group including one or more memory banks in the memory, a plurality of buffers, each buffer associated with a different bank group of the plurality of bank groups, a group selection module configured to receive one or more data transfer requests from the one or more processing elements, select one or more bank groups from the plurality of bank groups, and write the one or more data transfer requests in one or more buffers associated with the one or more bank groups, and a plurality of bank selection modules, a bank selection module associated with a bank group and configured to receive a memory address of a data transfer request stored in a buffer associated with the bank group and to select a memory bank from the bank group based on the memory address.

Example 9 provides the apparatus of example 8, where the data transfer request includes a request to read input data of the deep learning operation from the memory or a request to write output data of the deep learning operation into the memory.

Example 10 provides the apparatus of example 8 or 9, where the one or more processing elements and the group selection module are in a first clock domain, the plurality of bank selection modules is in a second clock domain, and the first clock domain is faster than the second clock domain.

Example 11 provides the apparatus of example 10, where the plurality of buffers includes a clock domain crossing buffer.

Example 12 provides the apparatus of any one of examples 8-11, further including a plurality of interconnects, each interconnect coupling a corresponding bank group to a corresponding buffer associated with the corresponding bank group for transferring data from the corresponding buffer to the corresponding bank group.

Example 13 provides the apparatus of example 12, where the one or more processing elements and the group selection module is in a first clock domain, and the plurality of interconnects, the plurality of bank selection modules, or the plurality of bank groups is in a second clock domain that is slower than the first clock domain.

Example 14 provides the apparatus of any one of examples 8-13, where a first bank selection module is configured to receive an address of a first data transfer task in a first clock cycle, a second bank selection module is configured to receive an address of a second data transfer task in a second clock cycle, and the second clock cycle is immediately after the first clock cycle.

Example 15 provides a method for a deep learning operation, including receiving, by a memory from one or more processing elements, one or more data transfer requests associated with the deep learning operation, the memory including a plurality of bank groups, a bank group including one or more memory banks; selecting one or more bank groups from the plurality of bank groups; writing the one or more data transfer requests in one or more buffers associated with the one or more bank groups; transmitting one or more memory addresses of the one or more data transfer requests from the one or more buffers to the one or more bank groups; selecting one or more memory banks from the one or more bank groups based on the one or more memory addresses; and transferring data between the one or more memory banks and the one or more processing elements.

Example 16 provides the method of example 15, where selecting one or more bank groups from the plurality of bank groups includes selecting two different bank groups for two data transfer requests received by the memory consecutively.

Example 17 provides the method of example 15 or 16, where the one or more processing elements are in a first clock domain, the plurality of bank groups is in a second clock domain, and the first clock domain is faster than the second clock domain.

Example 18 provides the method of example 17, where the one or more buffers includes a clock domain crossing buffer.

Example 19 provides the method of any one of examples 15-18, where each data transfer request includes a request to read input data of a deep learning operation to be performed by a processing element from the memory or a request to write output data of a deep learning operation performed by a processing element into the memory.

Example 20 provides the method of any one of examples 15-19, where transmitting the one or more memory addresses of the one or more data transfer requests from the one or more buffers to the one or more bank groups includes transmitting the one or more memory addresses through one or more interconnects, each interconnect coupling one of the one or more buffers to one of the one or more bank groups.

The above description of illustrated implementations of the disclosure, including what is described in the Abstract, is not intended to be exhaustive or to limit the disclosure to the precise forms disclosed. While specific implementations of, and examples for, the disclosure are described herein for illustrative purposes, various equivalent modifications are possible within the scope of the disclosure, as those skilled in the relevant art will recognize. These modifications may be made to the disclosure in light of the above detailed description.

1. A memory device for a deep learning operation, the memory device comprising:
a plurality of bank groups, a bank group comprising one or more memory banks in the memory device;
a plurality of buffers, each buffer associated with a different bank group of the plurality of bank groups;
a group selection module configured to:
receive one or more data transfer requests associated with a deep learning operation,
select one or more bank groups from the plurality of bank groups, and
write the one or more data transfer requests in one or more buffers associated with the one or more bank groups; and
a plurality of bank selection modules, a bank selection module associated with a bank group and configured to:
receive a memory address of a data transfer request stored in a buffer associated with the bank group, and
select a memory bank from the bank group based on the memory address.

2. The memory device of claim 1, wherein the group selection module is in a first clock domain, the plurality of bank selection modules is in a second clock domain that is slower than the first clock domain.

3. The memory device of claim 2, wherein the plurality of buffers includes a clock domain crossing buffer.

4. The memory device of claim 1, further comprising:
a plurality of interconnects, each interconnect coupling a corresponding bank group to a corresponding buffer associated with the corresponding bank group for transferring data from the corresponding buffer to the corresponding bank group.

5. The memory device of claim 4, wherein:
the group selection module is in a first clock domain, and
the plurality of interconnects, the plurality of bank selection modules, or the plurality of bank groups is in a second clock domain that is slower than the first clock domain.

6. The memory device of claim 1, wherein:
a first bank selection module is configured to receive an address of a first data transfer task in a first clock cycle,
a second bank selection module is configured to receive an address of a second data transfer task in a second clock cycle, and
the second clock cycle is immediately after the first clock cycle.

7. The memory device of claim 6, wherein the group selection module or a bank selection module comprises a demultiplexer.

8. An apparatus for a deep learning operation, the apparatus comprising:
one or more processing elements configured to perform the deep learning operation; and
a memory comprising:
a plurality of bank groups, a bank group comprising one or more memory banks in the memory,
a plurality of buffers, each buffer associated with a different bank group of the plurality of bank groups;
a group selection module configured to receive one or more data transfer requests from the one or more processing elements, select one or more bank groups from the plurality of bank groups, and write the one or more data transfer requests in one or more buffers associated with the one or more bank groups, and
a plurality of bank selection modules, a bank selection module associated with a bank group and configured to receive a memory address of a data transfer request stored in a buffer associated with the bank group and to select a memory bank from the bank group based on the memory address.

9. The apparatus of claim 8, wherein the data transfer request comprises a request to read input data of the deep learning operation from the memory or a request to write output data of the deep learning operation into the memory.

10. The apparatus of claim 8, wherein:
the one or more processing elements and the group selection module are in a first clock domain,
the plurality of bank selection modules is in a second clock domain, and
the first clock domain is faster than the second clock domain.

11. The apparatus of claim 10, wherein the plurality of buffers includes a clock domain crossing buffer.

12. The apparatus of claim 8, further comprising:
a plurality of interconnects, each interconnect coupling a corresponding bank group to a corresponding buffer associated with the corresponding bank group for transferring data from the corresponding buffer to the corresponding bank group.

13. The apparatus of claim 12, wherein:
the one or more processing elements and the group selection module is in a first clock domain, and
the plurality of interconnects, the plurality of bank selection modules, or the plurality of bank groups is in a second clock domain that is slower than the first clock domain.

14. The apparatus of claim 8, wherein:
a first bank selection module is configured to receive an address of a first data transfer task in a first clock cycle,
a second bank selection module is configured to receive an address of a second data transfer task in a second clock cycle, and
the second clock cycle is immediately after the first clock cycle.

15. A method for a deep learning operation, comprising:
receiving, by a memory from one or more processing elements, one or more data transfer requests associated with the deep learning operation, the memory comprising a plurality of bank groups, a bank group comprising one or more memory banks;
selecting one or more bank groups from the plurality of bank groups;
writing the one or more data transfer requests in one or more buffers associated with the one or more bank groups;
transmitting one or more memory addresses of the one or more data transfer requests from the one or more buffers to the one or more bank groups;
selecting one or more memory banks from the one or more bank groups based on the one or more memory addresses; and
transferring data between the one or more memory banks and the one or more processing elements.

16. The method of claim 15, wherein selecting one or more bank groups from the plurality of bank groups comprises:
selecting two different bank groups for two data transfer requests received by the memory consecutively.

17. The method of claim 15, wherein:
the one or more processing elements are in a first clock domain,
the plurality of bank groups is in a second clock domain, and
the first clock domain is faster than the second clock domain.

18. The method of claim 17, wherein the one or more buffers comprises a clock domain crossing buffer.

19. The method of claim 15, wherein each data transfer request comprises a request to read input data of a deep learning operation to be performed by a processing element from the memory or a request to write output data of a deep learning operation performed by a processing element into the memory.

20. The method of claim 15, wherein transmitting the one or more memory addresses of the one or more data transfer requests from the one or more buffers to the one or more bank groups comprises:
transmitting the one or more memory addresses through one or more interconnects, each interconnect coupling one of the one or more buffers to one of the one or more bank groups.
